(19) United States
(12) Patent Application Publication
(10) Pub. No.: US 2022/0237573 A1
(43) Pub. Date: Jul. 28, 2022

(54) METHOD AND SYSTEM FOR SECURE IDENTITY TRANSMISSION WITH INTEGRATED SERVICE NETWORK AND APPLICATION ECOSYSTEM

(71) Applicant: Jeffery J. Jessamine, Los Angeles, CA (US)

(72) Inventor: Jeffery J. Jessamine, Los Angeles, CA (US)

(21) Appl. No.: 17/375,269

(22) Filed: Jul. 14, 2021

Related U.S. Application Data
(63) Continuation of application No. 16/108,426, filed on Aug. 22, 2018, now abandoned.
(60) Provisional application No. 62/548,419, filed on Aug. 22, 2017.
(60) Provisional application No. 62/627,845, filed on Feb. 8, 2018.

(51) Int. Cl. G06Q 20/04; G06F 21/62; G06Q 20/40; G06Q 20/32; G06F 21/34; G06F 21/31

(52) U.S. Cl. CPC G06Q 20/045; G06F 21/629; G06Q 20/4014; H04L 63/0884; G06F 21/34; G06F 21/31; G06Q 20/322

(57) ABSTRACT

Method of generating a secure user identity data set, using timestamps and algorithms which can be encrypted, whose structure is generated in an initial communication between the communication device of the user and a remote identity server. The identity can be transmitted indefinitely to a client device from a user device while offline. The user's secure identity exists within a universally accessible network (cross-platform, cross-chain, cross-system, cross-application, cross-device, cross-industry) which provides the user with access to services and resources from providers who have integrated with the network. The network provides an application Ecosystem permitting a family of software applications that perform tasks and offer resources (smart contracts) such as payment processing terminals, point of sale use and exchange of virtual currency, ticket scanning and authentication, and requesting and receiving bids from service providers. The network also enables applications from one platform to execute smart contracts with applications residing on other platforms.

This application is a continuation of application Ser. No. 16/108,426 filed Aug. 22, 2018.

This application claims benefit under 35 USC 119(e) from Provisional Patent Application Ser. No. 62/548,419 filed on Aug. 22, 2017 and Provisional Patent Application Ser. No. 62/627,845 filed on Feb. 8, 2018, each of which is hereby incorporated herein by reference in its entirety.

### BACKGROUND OF THE INVENTION

The invention generally relates to comprehensive management systems and processes facilitating successful outcomes, and can be utilized for event management systems and associated event management processes. A primary focus is the creation and management of mobile application platforms that allow user and client groups to securely exchange data and information in pursuit of a common goal. The invention streamlines commerce and data interaction between product and service providers and consumers. Accordingly, the multilevel coordination and communication required to create an event and successfully execute it from a profit perspective are all important parts of the technical field. Events in this context include live performances, general services, and transportation; management in this context includes interfacing with systems and third party resources (including a tendering infrastructure to request and receive bids or crowdfunding for goods and services to establish or meet an event budget), data manipulation and communication, and security.

The invention is most generally described as being related to data security and management, more specifically, the security and management of user data before, during, and after transfers of user data from one device to another. This data security also covers secure acceptance and storage of user data and specifically user identification, and their linking with various privileges and permissions, including access rights, goods, and services. This technology includes data encryption and decryption methods, systems, and devices.

The invention's primary applications of data transmission security can relate to electronic ticketing and mobile payment processing. Furthermore, this invention relates to the sale of admission to live events and amusement venues and the subsequent purchase of goods or services offered by vendors at the live event or amusement venue and other user engagements.

Accordingly, the present invention can be generally related to electronic or digital tickets, commonly referred to as e-tickets. The invention encompasses the ticketing processes related thereto, such as the creation, assignment, management, transfer, acceptance, and usage of tickets and the permissions related thereto such as entry, reentry, access, exit, and VIP.

This invention also generally relates to e-ticket authentication and verification to prevent unauthorized access and ticket counterfeiting.

Additionally, the present invention relates to mobile payment processing and financial transactions governing various goods and services. More specifically, the present invention conveniently combines e-ticketing and purchasing under one digital platform. The ticketing and payment technology addressed herein includes ticketing, access control, mobile wallets and cashless payments (fiat, virtual or cryptocurrency), brand engagements, Point of Sale (POS), and systems. These systems may be used interchangeably or described independently.

The relevant device technology using the inventive platform and system includes mobile devices such as smartphones, receiving devices such as secondary mobile devices or smartphones or terminals, acquirer certified payment terminals, point of sale machines such as cash registers, and wristbands.

The present invention utilizes short-range communication technology between mobile devices and receiving devices to control access and payment. These short-range communication technologies include inter alia: Near Field Communication (NFC), QR codes, data embedded images, unique identifiers, frequency transmission, and audio signal transmission in the form of inaudible frequencies. The invention's methods and systems can, if needed, utilize long range communication technology or any other form of electronic communication.

The present disclosure also generally relates to near field communications (NFC) and more particularly to systems, methods and computer program products for facilitating the validation of payment and other transactions involving NFC-enabled mobile devices.

The present invention also relates to the field of providing services to patrons at a venue and tracking the patrons' consumption habits of venue products. Similarly, the present invention corresponds to data collection and mining to include user demographics, spending habits, and similar statistics.

### BACKGROUND ART

Before the advent of computers, tickets for events were printed on paper and physically distributed to individuals who desired to attend a specific event. In order to streamline this ticketing process, most ticketing systems now include some sort of electronic components. For example, the ticket purchasing process has become more distributed. In the past, a person would have to wait in line at the box office located at the event facility. Now, individuals can purchase a ticket for virtually any major event in a city by visiting a ticket kiosk located near their home or through the Internet; however, the ticket delivery process has not improved significantly, as discussed below.

Often, tickets can be bought electronically from ticket kiosks that are located in large supermarket chains, other centralized locations, or through the Internet. Consider the scenario where someone desires to obtain a ticket electronically—whether through a kiosk or over Internet. First the purchaser goes through a process that determines whether a ticket is available by accessing a central database. If a ticket is available, the purchaser purchases the ticket and pays the price of the ticket plus a ticket service charge. Then the ticket is printed out on a piece of paper and either given to the purchaser if the ticket is bought at a kiosk or mailed to the purchaser if the ticket is bought over the Internet. Sometimes, the purchaser is simply given a confirmation number, which is to be used later to redeem a physical, printed ticket at the event.

The printed tickets often have a barcode to identify the ticket, which may be scanned when the person arrives at the event. But even with a reduced paper system, this system still requires that an actual ticket must be printed at some point in the process either at a kiosk or at home on a printer.

In the current market a person can purchase a ticket to an event/venue and the ticket is either delivered in paper form (paper ticket with most commonly a barcode or QR CODE™ printed on it) by mail or in person, or in an electronic paperless form using a unique identifier and/or a data-embedded object such as a barcode or QR CODE™, herein also collectively or individually referred to as “code” or “codes” or a unique identifier, typically by email or within an application where the ticket purchase originated. The ticketholder presents the ticket in paper or in electronic form at the point of entry to the event/venue, airline or other scenario and a stationary or mobile device (1 D, 2D scanner or device equipped with a camera, or laser, and ability to read codes) reads the ticket's unique identifier or code to verify and validate the ticket's credentials.

There are varying circumstances of where an electronic ticket can be stored and accessed. The following are some of the most common locations to store a ticket on a mobile device, including but not limited to, in the form of the email that the ticket was delivered to upon purchase, the patron opens the email and displays the ticket's unique identifier or code for scanning; the ticket is moved into APPLE WALLET™, GOOGLE WALLET™, PASSWALLET™ or similar apps for ease of access and other benefits; the ticket is intentionally transferred to, or purchased and opened in a custom application such as a ticketing company's, venue's, festival's, airline's, NHL, NBA, MLB or NFL, or other sport league or franchise application.

Once the patron enters the event/venue, airplane, etc., they are now able to make purchases from the airline Attendant, at concession stands, order from their seat (offered in some venues), merchandise outlets or other vendors. The payment options can be: credit card, debit card, banking account, credit account, debit account, PAYPAL™, VENMO™, APPLE PAY™, GOOGLE WALLET™, ANDROID PAY™, cryptocurrency (e.g. BITCOIN™), or cash.

APPLE WALLET™, GOOGLE WALLET™, PASSWALLET™, APPLE PAY™, or GOOGLE WALLET™ all allow a ticket to be stored within them, which means that you can flip back and forth between the ticket with its unique identifier or, and the payment options within these apps that use NFC technology within either an Apple or Android mobile device to transact.

### SUMMARY OF THE INVENTION

According to the invention there is provided a method for completing a transaction between a user and a client who is a supplier of goods and/or services comprising:

providing a personal communication device (PCD) which is associated with the user;

providing a receiving communication device to the supplier;

on a remote identity server storing information from the PCD relating to the user;

in preliminary information exchange between the PCD and the remote identity server, establishing a data set structure sharing a special relationship between the remote computing device and the receiving device;

in the event that the user wishes to obtain goods and/or services from the supplier, causing the PCD to generate and transmit to the receiving device the data set;

causing the receiving device to forward the received data set to the remote identity server for validation, processing, and identification of the user, the remote identity server acting to provide data to the receiving device identifying the user;

the data set being established such as to only be recognizable as valid by said remote identity server, and to not be easily reproduced by an unauthorized third party.

While the data set can be established using many different protocols, preferably the data set structure established in the preliminary information exchange between the PCD and the remote identity server contains a data relating to a timestamp of the information sent to the remote identity server by the PCD.

That is the identity server is central to all of this, and there can be any number of PCD's associated to the same user. The identity server in the preliminary information exchange, calculates a time difference being the difference between the time the PCD has, and what the remote server has. The PCD is arranged to transmit its timestamp to the remote server and the remote server stores the time difference, not the PCD. The generated data set defined herein is called an SID.

The time difference is calculated when the PCD logs in, but can be updated in supplemental communications it wanted, needed, or desired.

Whenever a SID is created, it contains the new or now-current timestamp of the PCD.

When the remote server receives the PCD via the receiving device, it will calculate the new time difference from the new timestamp, and its new or now-current timestamp. If the new time difference is different from the original by a certain predetermined amount, then the SID is invalid.

A SID with an old timestamp is invalid because it is likely stolen by monitoring previous communications but could also be because the PCD is out of sync, that is, its time was changed.

A SID in is regenerated periodically for example every 10 seconds, so 15 seconds is the maximum time difference which is allowed to be different from the original.

That is part of the protocol involves the difference checking code which acts to check for the difference greater than or less than the original, but the difference likely will always be greater due to delays in it being transmitted to the remote server.

That is, preferably the remote server and the PCD generate at the log in process a structure for the data set to be later regenerated during authorization where the data set established in the preliminary information exchange between the PCD and the remote identity server contains a data relating to a difference between a timestamp of the information sent from the PCD and a timestamp of the remote identity server.

In some cases the data set can contain a unique identifier generated by combining said data relating to the timestamp with a unique mathematical algorithm provided to the PCD by the remote identity server, at the time the device sent its then-current timestamp and received its credentials.

Preferably the data relating to the timestamp and/or the unique mathematical algorithm within the data set is encrypted such that it can only be decrypted by the remote identity server.

Preferably the whole dataset is encrypted such that it can only be decrypted by the remote identity server.

Preferably the PCD does not have a data connection to remote identity server, and instead relies upon a local server, or local data on the device in order to complete the identification, where the local server or data contains the required special relationship data that would otherwise be stored on and decrypted by the remote identity server.

Preferably the PCD is required only to transmit the data set to the receiving device so that no two-way communication is required of the PCD after the data set was initially granted and provided by the remote identity server.

Preferably when the receiving device receives back from the remote identity server a unique identification of the user and the remote device uses that identification to provide said goods and/or service.

Preferably the unique identification received is unique to the user.

Preferably the unique identification is forwarded by the receiving device to one or more additional computing devices to perform or assist to provide said goods and/or service.

Preferably the receiving device also sends service data/parameters along with the data set to the remote identity server which then performs a service.

Preferably the remote identity server forwards a service request to one or more service providers, as defined by the service data/parameters to perform or assist to provide said goods and/or service.

Preferably the data set is transmitted by the PCD via two or more communication methods simultaneously and the receiving device chooses which of the methods it will use.

Preferably the user is authenticated by the remote identity server on a plurality of different devices and/or software applications simultaneously.

Preferably a payment terminal forwards an input it cannot process along with details of the amount to charge and merchant to credit to a server which identifies the input format and content and processes the payment accordingly.

Preferably either or both the PCD and receiving device may switch roles, depending on the situation, the user authenticated on the device, the abilities/features of the device, and the software configured on the device.

Preferably the method further comprises providing a network connected to said remote identity server for centralizing and standardizing software application or service data such that it can be shared, viewed, and utilized universally by any number of software applications and services where the software application or service data are compatible with the network and where specifications for the format and structure of the are documented and at least partly shared, and there is provided a universal interface for communications between said remote identity server and said software application or service data.

While the method defined in the above paragraph includes the remote identity server and the unique user identification method defined above, the network defined can be used without the remote identity server or using alternative identifications methods.

Thus the method of the present invention can provide a universally accessible Service Ecosystem, or Centralized Identity Service Network (“CISN”). The CISN provides the user with access to services and resources. The CISN also allows service and resource providers to integrate with the network (“Integrated Service Providers”) to provide or offer services or resources. The CISN may enable the Integrated Service Providers to access additional resources such as services, software applications, information, hardware, confirmations, payments, etc, through the CISN intercommunications channels from other Integrated Service Providers, and may enable access the interconnected Application Ecosystem. The Application Ecosystem or network is thus a family of software applications that perform tasks and offer resources such as payment processing terminals, point of sale (“POS”), use and exchange of virtual currency tokens or cryptocurrencies, airline or event ticket scanning and authentication, and requesting and receiving bids from service providers. For example, a third-party event ticketing company that becomes an Integrated Service Provider can access the POS application to sell items to a user and accept payment from the ticket holders secure user identity means of transmission, that has acquired both its event access ticket, and its payment method via a mobile wallet. Another example is a certified payment terminal that contains the CISN mobile application can now accept payments by requesting such payments from the secure user identity through the CISN (which can be any acquirer, mobile wallet, cryptocurrency wallet etc, provided that these payment issuers are Integrated Service Providers).

Thus the arrangement defined above with or without the unique method of identification defined above can have one or more of the following optional features.

Preferably a virtual currency is available in the network as a universal payment means between any group or user associated with the network.

Preferably the software applications and/or services communicate together and use their combined data to more accurately make group and user decisions.

Preferably a connection to the network is fully active but the software applications and/or services continue to work mostly together to reduce load on the connection to the universal interface.

Preferably an intermediary lesser control server is implemented in closer proximity to the software application and/or services to further reduce load on the connection to the universal interface.

Preferably the lesser control server also behaves as a peer in some cases, to assist with the application and/or service decision making.

Preferably data pertaining to usage of the network by the PCD is tracked for statistical, analytical, and reporting purposes wherein data is provided to and/or accessed by service providers in such a way that personal/private and/or identity information is hidden.

Preferably advertising and/or marketing is developed and/or delivered to users and/or groups of users or accounts based on specific activities of each within the network.

Preferably the universal interface forwards some of all of the input to another service provider of its choosing based on the input to assist with or perform a service.

Preferably software applications are built and configured in a hierarchal way, such that some software applications control the permissions, and features of other submissive software applications; thus, permitting control over how some software applications function, via one or more higher level software applications.

Preferably a user or account creates new accounts with service providers simply by selecting them via an interface of the network, and agreeing to that service provider's terms of service, if required by the service provider.

Preferably a user or account acquires new accounts with service providers automatically when the user or account interacts with that service provider using the network.

Preferably two or more users or accounts may transfer digital assets between one another, record the transfer of physical or monetary assets, and/or a combination of each.

Preferably when there is no immediate communication connection between devices of users or accounts of all parties involved in the transfer, and the universal interface, the transfer may be recorded by one or more devices, of which may or may not be one of the devices of an involved party, but which could also or instead be that of a trusted third party.

### Definitions of Terms Used Herein

SID—Secure Identity Dataset—a set of data configured and/or structured in such a way that it can be used by the identity network to identify a user, but that cannot be effectively stolen, or used by a party outside the network.

UID—Unique ID—an identifier consisting of a string of alphanumeric characters that is unique to that which it was applied (user, device, etc), in the context in which it was applied.

SDK—Software Development Kit—a collection/set/package of computer code, libraries, and or software which can be integrated into another software application. The code in the SDK provides features and functions to the integrating software that would otherwise not be available, or would not be practical to develop from scratch.

“Data embedded object” (DEO) or “Data Embedded Image” (DEI) are terms used throughout the specification and/or claims and is accordingly defined as any visual form of unique identifier e.g. barcode, 2-D barcode, 3-D barcode, or QR code. We have elected to use the term QR Code in many instances because it is the most common form of a data embedded object used within the ticketing industry.

User—is an entity which can be an individual, company or other entity who wishes to be identified via the identity network in order to receive a service. The user can also include an account contained within a financial service associated with the user per se.

Client—an individual, company or other entity who wishes to identify a user via the identity network in order to provide goods or a service to them.

A smart contract is a computer protocol intended to digitally facilitate, verify, or enforce the negotiation or performance of a contract. Smart contracts allow the performance of credible transactions without third parties.

Tickets typically provide access to events, proof of purchase, credentials to restricted areas, as well as many other benefits. In the past, traditional tickets used for an event existed as a hard copy or paper form. However, such tickets may be lost or misplaced, may have limited use, may not easily be transferred if at all, are environmentally unfriendly, and may provide a limited range of benefits including the lack of, or minimal consumer information gathering. The main realization that this invention focuses on is that a ticket is no longer actually just a ticket, instead a ticket should be viewed as a gateway to a personal profile and all the features and capabilities that flow therefrom.

Today most consumers maintain a personal electronic device in the form of a mobile phone within arms-length at all times. Accordingly, when people attend various ticketed events, they possess their personal electronic device and a form of payment for additional goods or services. Using the techniques, systems, and devices described in this patent, a user will be able to obtain, store, or use a ticket in a device like a smart phone to gain access to an event, unlock additional benefits or services, and pay for goods or services.

There are many issues in standardizing a mobile payment in today's world. One of the main issues is that using an Apple device for mobile payment is that it only works with a receiving unit equipped with APPLE PAY™, or otherwise authorized by Apple, and that the NFC within the Apple device is generally restricted and unable to work outside of Apple's technologies (Apple devices, APPLE PAY™ iTunes Concert Ticket™). Further, there is still a large portion of the population that does not currently use a QR Code based payment application, APPLE PAY™ or GOOGLE WALLET™ (or other similar mobile payment options), and some people have no interest in doing so at this point. Businesses are striving to reduce queue times, increase sales, gather consumer information, and enhance the customer experience, but this fails when a customer wants to use an actual card or pay with cash. Moreover, there is no such thing as a universal mobile payment option that is used by both Apple and Android which vendors or merchants commonly accept. Convincing the world that there should be one universal mobile payment solution is easy, and has been done for the most part, however, due to many business decisions from various companies involved in the payment, software or hardware businesses, for example Apple restricting the use of its NFC technology within its hardware devices, it is not practical to think that this is even a possibility in the near or distant future.

That said, when it comes to ticketing for any venue, event, airplane, conference, festival, etc, the one item a person needs to gain access to one of the above is a valid ticket.

One of the primary objectives of the subject invention is to align a mobile/cashless payment option with the ticket itself, or to align these and other information with the user, providing it with a single method to transmit any information associated with the user that is requested by a receiving device. Ticketing companies are not about to let the payment companies take over their ticketing platforms to allow an integrated system and vice versa. For instance, if one were use the NFC technology for ticketing, it would be forced to use Apple technology including all Apple software and hardware which would preclude anyone with a non-Apple device from participating. Ticketing companies, promoters, event/venue owners, airlines, etc. will not subject themselves to a situation that limits consumer participation.

When you consider the amount of tickets sold in various markets, it is one of the largest industries in the world. If one were to funnel the patrons buying and using tickets into a single mobile payment platform by simplifying the entire experience, it would be one of the greatest accomplishments in the history of mobile payments. In order to funnel ticket buyers into one mobile payment option, it would have to be driven by the ticketing companies since it is their customer base that is the main target (initially) of the proposed technology.

Accordingly, a primary objective of the present invention is to provide a mobile device platform, system, and method for securely controlling access and executing transactions. The proposed invention/solution is to use the ticket itself, or a single method to transmit any information associated with the user that is requested by a receiving device, which can be a request to authenticate the user who has obtained a ticket for access, or has a mobile payment method associated with the user. However, payment security and personal information protection is the primary obstacle when one considers joining ticketing (storing and presenting ticket) & payments into one dual purpose application (ticket and payment).

The primary objective is to provide a secure user identity which can be transmitted indefinitely from a user device while offline (in airplane mode) without any connection to the internet, or other local or public network. A user's secure identity exists within a universally accessible Centralized Identity Service Network (“CISN”). The CISN provides the user with access to services and resources. The CISN also allows service and resource providers to integrate with the network (“Integrated Service Providers”) to provide or offer services or resources. The CISN enables the Integrated Service Providers to access additional resources such as services, software applications, information, hardware, confirmations, payments, etc, through the CISN intercommunications channels from other Integrated Service Providers, and enables access to the interconnected Application Ecosystem. The Application Ecosystem is a family of software applications that perform tasks and offer resources such as payment processing terminals, point of sale (“POS”), use and exchange of virtual currency tokens or cryptocurrencies, airline or event ticket scanning and authentication, and requesting and receiving bids from service providers. For example, a third-party event ticketing company that becomes an Integrated Service Provider can access the POS application to sell items to a user and accept payment from the ticket holders secure user identity means of transmission, that has acquired both its event access ticket, and its payment method via a mobile wallet. Another example is a certified payment terminal that contains the CISN mobile application can now accept payments by requesting such payments from the secure user identity through the CISN (which can be any acquirer, mobile wallet, cryptocurrency wallet etc, provided that these payment issuers are Integrated Service Providers).

Another main objective of the present invention is to: provide universal ticketing and payment system for all device platforms commonly accepted by vendors at entry points and POS to operate as a single, comprehensive payment platform for ticketing and POS; marry a mobile/cashless payment system to the e-ticket itself with an expiry of the ticket which would detach the e-ticket from the payment token for security reasons.

Other objective capabilities include: funnel at point where customer buys ticket, ticketing company forces user to use application and tie payment information/profile to the ticket at the time of purchase; ticket (e.g. e-ticket or paper ticket) itself is mobile payment; payment security and personal info protection; mobile entry and cashless POS transactions; ticket transfers via application; provision of funneling sources, ticketing portal; allowing users to transfer or distribute tickets, tickets can be resold or transferred within application, application allows patron to receive ticket from ticket purchaser and attached his/her own payment to ticket; and, white labeling by ticket companies.

The invention is generally a user identification central system that can be used, for example, as an event management system having multiple discrete platforms used by users and clients for interfacing with the system. The event management system provides clients with the ability to create an event and manage myriad details of its conception, implementation and execution. The event management system provides users, namely guests and consumers, with a convenient all-in-one mobile application utility for accessing events and executing transactional payments. Additional discrete platforms including integrated third party apps and platforms, are provided for clients including a Producer app (super administrator application), a Patron app (the user/consumer application), and other applications that provides resources, goods and services, are included within our P7 family of apps that include Point (point of entry, point of sale, point of engagement), Personnel (human resource procurement and management), Performer (entertainer/artist procurement and management), Promotion (sponsor procurement and management), Provider (subcontractors and supplier procurement and management), applications, which connect patrons, artists, suppliers, subcontractors, producers, promoters and advertisers, personnel and management, allowing them to successfully collaborate on events, and for the event producer or organizer to procure all these resources, goods and services through a tender call, to negotiate pricing and terms, raise funding, and to successfully execute an event. The event management system includes a comprehensive dynamic security apparatus that protects the storage of data and the transfer of data between users and clients with the goal of eliminating fraudulent activity.

The overall concept of this invention is for a Patron to use his/her system generated user identification or ticket (the data embedded object/unique identifier or other form of communication corresponding to the ticket or other transmission and/or receiving methods) for both obtaining access and as a mobile payment solution for cashless purchases. The generated user identification or ticket would be used within its placeholder within any application (including integrated third parties) for the multi-purpose of gaining access and making purchases, or other engagements at any event, venue, transportation vessel, trade show, conference, transportation system and/or vehicle, or other establishment that offers goods and/or services. The generated user identification or ticket being a data embedded object, would be altered in some cases by the application or server to enable the access credentials to be maintained within it, while also adding unique identifying information to it that pertains to the payment credentials, or replaced, or would continually change within the application or within the server (by fetching and pushing or other form of communication between the server and the application); however, the Patron would not be able to identify any difference on the ticket itself. The following demonstrates the user flow from the point of ticket purchase to making purchases with the ticket and the specific technology security measures developed to enable the invention to be compliant with the payment card industry and other regulatory bodies. The concept of this invention is for a Patron to use his generated user identification or ticket for both access, cashless purchases, and other engagements; however, in the case of utilizing the user identification within the application, ticket and payment methods would be associated with the user identification, and a receiving device would request the server to confirm if there is a valid ticket or payment method associated with the user's identification.

In a departure from the prior art however, the present invention benefits the consumer by providing multiple means of proximal communication between a user device and a client device by envisioning the use of a platform application installed and operated on a smartphone device that utilizes the advanced software and hardware communication capabilities of the smartphone. In a preferred embodiment, both the user device and client device are similar or identical smartphones in form, function, make, and/or model that operate a similar or identical application platform. This maximizes the proximal communication capabilities of the system that operates between a first user device and a first client device.

The proximal communication system represents and improvement in the prior art in that it is capable of transmitting data and information using multiple communication protocols simultaneously sequentially or simultaneously to maximize the speed of communication and efficiency of system load and operation. The means of proximal communication are represented by multiple proximal communication protocols intended to be operated by the client device and/or user device, and these protocols capable of being processed or incorporated by the system are well-known in the art including, but not limited to: a Near Field Communication (NFC) means; a Bluetooth means; a Bluetooth Low Energy (BLE) means; an audible or inaudible sound or frequency; an ultrasonic signal transmission; a Radio Frequency Identification (RFID) means; a WiFi means; a Graphical User Interface (GUI); a Graphical Client Interface (GCI); a data embedded image (DEI); a barcode; a Quick Response (QR) code; light or laser, and, any other wireless form of communication.

Furthermore, the present invention is designed to use a user and client's existing infrastructure, e.g. their respective smartphones to operate a platform that serves as a comprehensive electronic ticket and mobile payment device that is reusable at a plurality of different events and venues. The present invention focuses on developing a convenient universal user identification central system that can provide a ticketing and payment system that allows consumers the added convenience and functionality of a single reusable mobile device or pass that can be used at a plurality of events across different geographical locations, which may even be managed by unaffiliated event operators.

Essentially the prior art is locked in the old fashioned paper ticket model that provides a one-use ticket for one event or venue. In the present invention, once the patron activates his mobile device, pass, or bracelet ticket, he is free to write his own ticket to a network of live events using that one mobile device or pass.

In one form of the invention a mobile device or pass website prompts patrons to sign up to become a member of the universal user identification central system by filling out a personal information profile which may include personal data, preferred and/or required contact information, and credit/debit information. The web site may include a personal profile home page, providing an intuitive experience for patrons to manage their live events by searching for and buying event tickets, adding value to their mobile device or pass profile, request pricing and book hotel accommodations and airfare, write reviews for free rewards and more.

The unique RFID chip and/or barcode identifier and/or means capable of transmitting or receiving data can be implanted or printed on the mobile device or pass of this invention. This electronic communication mechanism links to a corresponding unique member's profile that includes all of the above personal and credit information and communicates with the computer data system when it is scanned by a reader at an event or venue. After the mobile device or pass is scanned by the reader, the privileges associated with that individual spectator's identification, mobile device, or pass account, are verified by the computer data system. Privileges being verified by the mobile device or pass system may include access privileges (did this person buy a ticket to the event?) and purchasing power privileges (are there funds available on this account to pay for a purchase at the concession stand?) among others.

The present invention takes a novel and innovative approach to the outdated ‘one physical ticket for one event’ conventional ticketing model, by introducing a universal user identification central system, that can be used for among a multitude of other things: ticketing, and payment systems that offer consumers the ability to use one universal mobile device or secondary device such as an RFID chip, that works at a multitude of venues across a network of live events, venues, airlines, etc.

Though there have been previous innovations which combine a mobile device or bracelet with a barcode or RFID chip providing access control and payment applications by the competition and others who have developed online e-ticketing systems, the preferred forms of the present invention are superior to the prior art in many distinct and meaningful ways, including: 1. Replaces conventional paper tickets and e-tickets; 2. Replaces the practice of printing out and bringing an additional ‘print at home’ e-ticket document for access privileges to events; 3. Reduces threat of counterfeiting and associated costs associated with printing and distributing old-fashioned paper tickets; 4. Increases convenience for spectators by combining access privileges with POS payment functionality among other privileges onto one universal mobile device, or pass, that works seamlessly for such purposes across a network of live events; 5. A payment system that tracks financial transactions at every event in the network back to a specific spectator's universal mobile device or pass account; 6. Provides valuable business intelligence and data mining opportunities concerning vendor sales, inventory and spectators' buying history and brand preferences; 7. Reduces waiting time to gain admission to events and speeds up waiting lines at souvenir gift shops and concession stands; 8. Cashless transactions have been shown to be higher value transactions; and, 9. Reducing cash transactions at events reduces shrinkage and theft; and reduces the time required to gain access to an event or obtain a good or service at a venue.

One of the major benefits of the mobile device or pass system, is that it offers event managers the capability to make events completely cashless if desired. A cashless event means that vendors and organizers need keep little or no cash on hand, which reduces shrinkage, loss, and theft, and otherwise lowers costs associated payment and product security or event security. And because every transaction is tracked through the universal user identification central system, and the mobile device or pass accounting system, organizers who take a percentage of total sales can hold vendors 100% accountable. Spectators to events using the mobile device or pass will move through waiting lines faster and will have more time to enjoy the show. Research shows that cashless transactions are generally higher value compared to cash transactions and faster lines at concession stands will translate to more transactions per event. This means more revenue and profit for event organizers. Using the mobile application to pass the user identification to the RFID or other secondary device (eg. smart watch), and to be able to manage all account functions within the mobile application, further streamlines the process for spectators and event staff alike, as the spectator can self-serve, reducing the amount of time and/or number of staff needed to assist the same spectators with that process.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by embodiments and optional features, modification and variation of the concepts herein disclosed may be resorted to by those skilled in the art, and that such modifications and variations are considered to be within the scope of this invention as defined by appended claims.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

Several embodiments of the subject technology are set forth in the following figures.

FIG. 1 illustrates a first embodiment of a Secure E-Ticketing Mobile Payment System.

FIG. 2A illustrates a user purchasing a ticket and creating a user account using the first embodiment of the Secure E-Ticketing Mobile Payment System.

FIG. 2B illustrates a user performing an action, e.g. access or payment, using the first embodiment of the Secure E-Ticketing Mobile Payment System.

FIG. 3 illustrates operation of an Integrated Security System of the first embodiment.

FIG. 4 illustrates operation of a Proximal Wireless System of the first embodiment.

FIG. 5 is a block diagram illustrating the high level system architecture for use of the identity network to identify a user and their related account(s), in order to take a specified action.

FIG. 6 is a block diagram similar to FIG. 5 that instead utilizes the identity network to additionally forward the request on behalf of the client, as opposed to just being used for user and account identification.

FIG. 7 is a block diagram similar to FIG. 5 that illustrates how the identity network can be utilized as an intermediary to provide service connectivity between normally unrelated service providers.

FIG. 8 is a block diagram illustrating a computer system architecture which has been configured for use by a user wishing to be identified via the identity network.

FIG. 9 is a block diagram illustrating a computer system architecture which has been configured for use by a client wishing to identify a user via the identity network.

FIG. 10 is a flow diagram illustrating the process of a user's identity being used to process an action by the requested service provider, as illustrated in FIG. 5.

FIG. 11 is a flow diagram similar to FIG. 10 that instead of FIG. 5, illustrates the process used for the architecture illustrated in FIG. 6.

FIG. 12 is a flow diagram similar to FIG. 11 that illustrates the process of taking data generated by the hardware and software of one service provider, and having it processed using the same of two other service providers, in order to fulfill the requested action.

FIG. 13 is a block diagram illustrating the high level architecture of the identity network server, and database.

FIG. 14 is a block diagram illustrating several possible SID architecture styles.

FIG. 15 is a block diagram illustrating the inclusion of a virtual currency into the identity network in order to facilitate payment transfer between service providers.

FIG. 16 is a block diagram illustrating the high level system architecture for a scalable service ecosystem which incorporates the identity network, and any number of other services and features.

FIG. 17 is a block diagram illustrating a high level system for universally handling forms of payment through a payment terminal.

FIG. 18 is a block diagram illustrating the high level relationship between a user, and their service provider accounts.

FIG. 19 illustrates a second embodiment design comprising an event management system having three application platforms.

FIG. 20 is a modified version of FIG. 5 showing further detail of the second embodiment design.

FIG. 21 illustrates a the design comprising an event management system having five application platforms and a central server.

FIG. 22 illustrates an application hierarchy and functions of the third embodiment design.

FIG. 23 illustrates operation of the second and third embodiments using an account based QR Code Design.

FIG. 24 illustrates operation of the second and third embodiments using an event-based QR Code Design.

FIG. 25 illustrates an access operation of the second and third embodiments using a Point

FIG. 26 illustrates a POS Coupon Payment operation of the second and third embodiments using a Point Application and QR Code Design.

FIG. 27 illustrates a POS Credit Card Payment operation of the second and third embodiments using a Point Application and QR Code Design.

FIG. 28 illustrates a fourth embodiment design comprising an event management system incorporating blockchain technology.

FIG. 29 illustrates a processing of a user request under the fourth embodiment.

### DETAILED DESCRIPTION

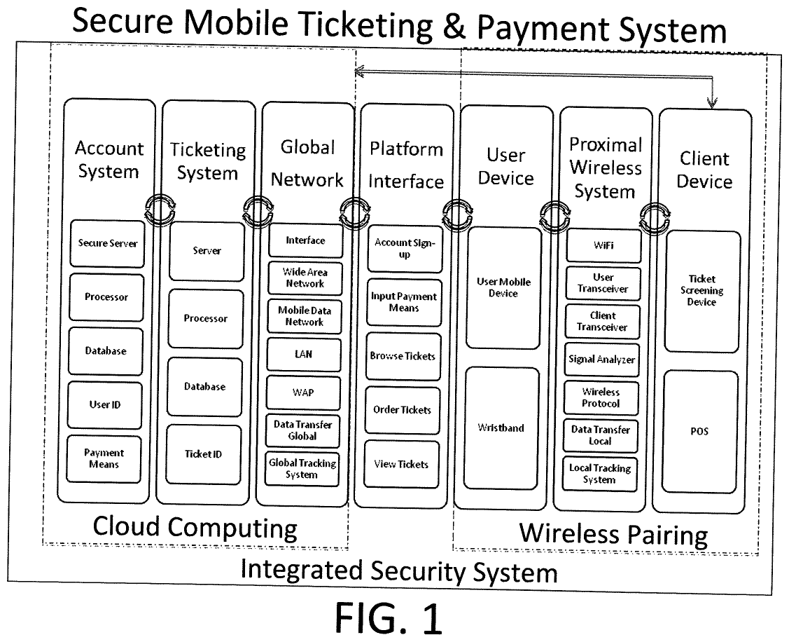

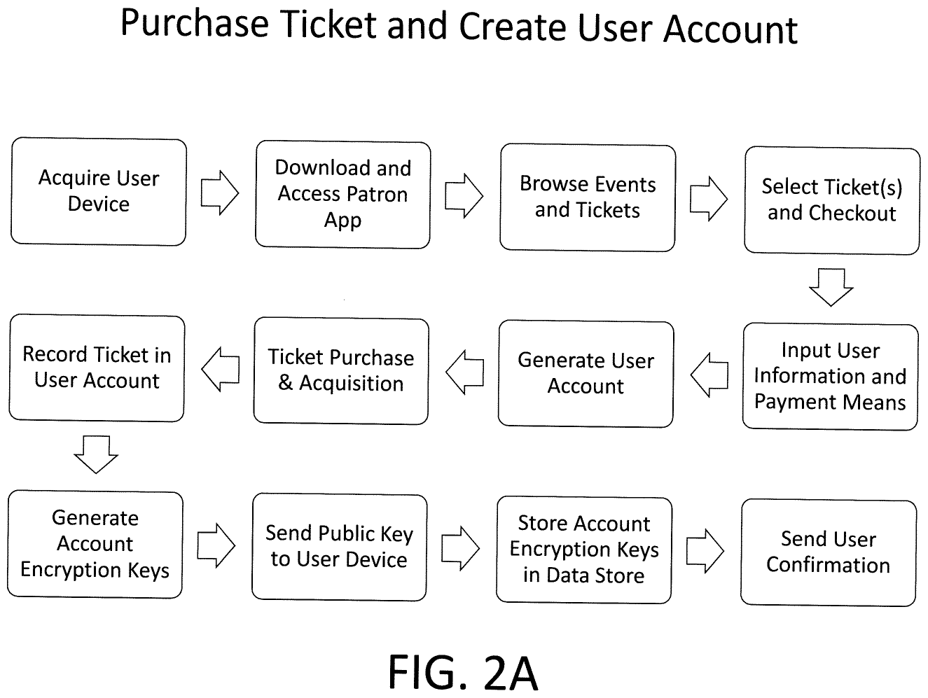

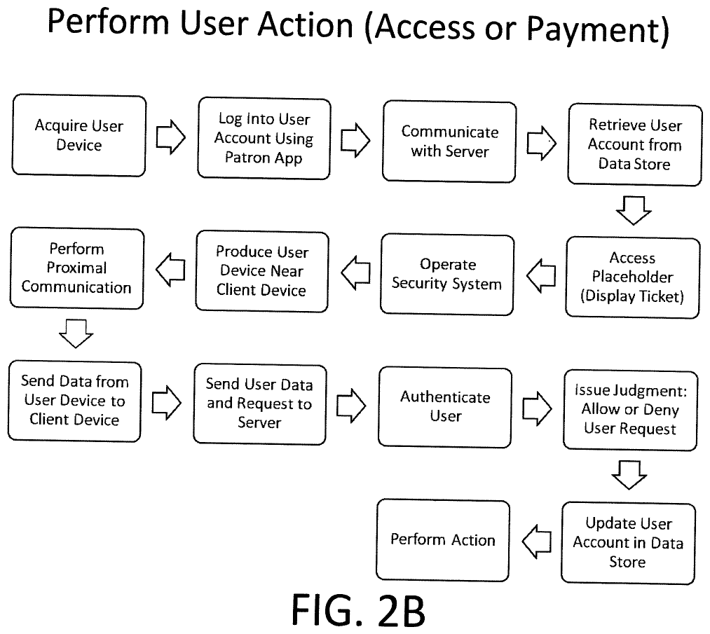

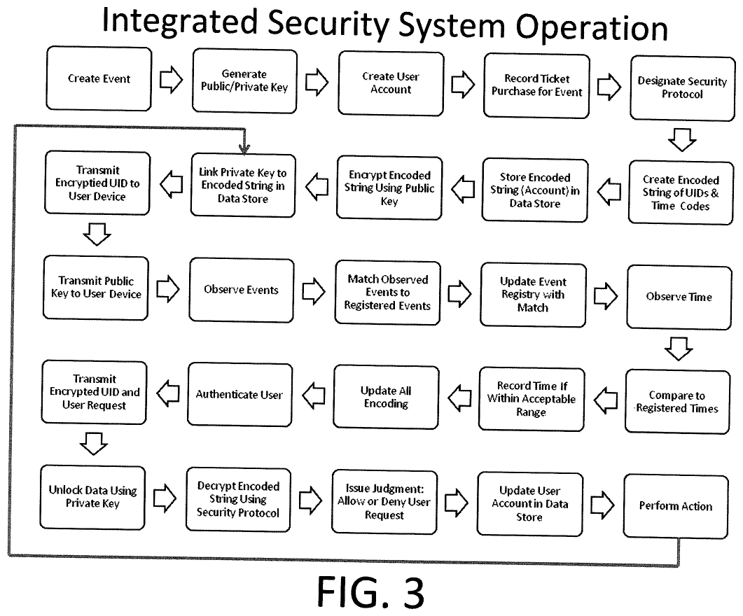

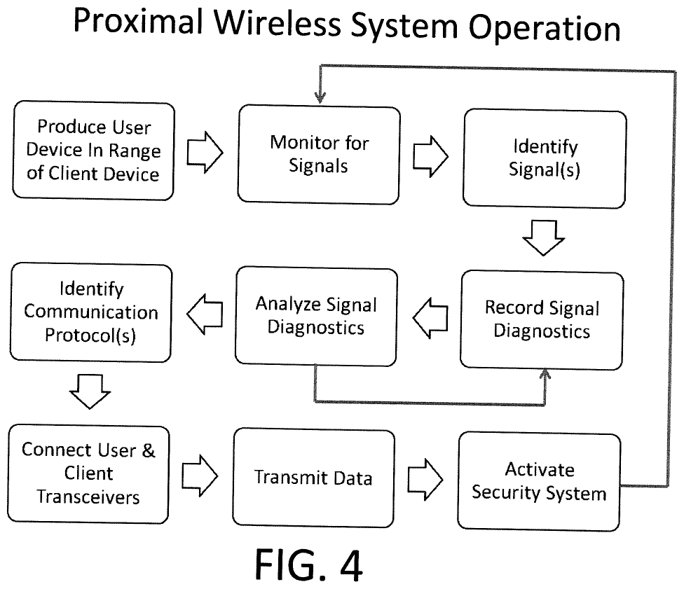

The invention in one application of use refers to an event access and payment system shown in FIG. 1. Operation of the overall system in this application of use is schematically shown in FIG. 4 with its security system design and operation schematically illustrated in FIGS. 2A and 2B and its proximal communication system design and operation schematically illustrated in FIG. 3.

The system operates using user account information. Appropriate user identifying data and/or payment means data is stored locally on the user and/or client device and/or can be accessed by communication with a user's account or profile on the computer data network. This allows the user to charge food, drinks and other goods and services offered for sale at the event either to a pre-established pass account, or based on a particular “value” initially stored in the device. Such stored-value and gift card technology is well understood. Preferably, additional value may be added to the user mobile device or bracelet or wristband or badge or secondary device having proximal communication capability at the event, that is to say, the patron can use cash or other funds to add to the funds available on the user mobile device or bracelet at the event. The user possessing the user mobile device or bracelet is able to purchase the additional value at an event and add that value to the user mobile device or bracelet.

The system in this application of use essentially operates as a ticketing platform that conveniently allows for payment of goods and services. The invention is a customized mobile POS RFID cashless solution for food and beverage festivals, specifically for non-access ticketed events. A patron simply pre-registers and attaches funds to their RFID ticket, which is transmitted electronically to the patron ahead of the event. This is not possible for non-access ticketed events because you don't know who is going to attend the event until they arrive on-site. That said, using a cashless system in this circumstance would require a lengthy patron onboarding process onsite after patron arrival that would include disbursing RFID wristbands, patron agreeing to terms & conditions, taking payment from credit cards, and attaching the payment token to the wristband. Once the wristband is activated the patron would use his/her wristband to tap after each purchase and the payment would be processed. This is a substantial step to take from the previous year where patrons simply purchased paper tickets and paid for food and beverages with these tickets. Another downside is the limited room within the vendors station and having to install large cumbersome point of sale systems that take a substantial amount of the table space used to serve the menu items to the patrons that require wires all over the festival grounds.

The present disclosure is directed to systems, methods, and computer program products for facilitating the mutual, token-based validation of contactless payment and other transactions involving NFC-enabled mobile devices that may or may not support card emulation.

The advantages of the innovative ticketing and payment system are numerous. The system seamlessly integrates existing customer services into one feature, and minimizes the effort necessary for users to adopt or transition to the new cashless ticketing solution, providing less of a shock to the patrons and the event staff compared to alternative ticketing transitions. Compared to a legacy paper ticketing system, the primary change is that the event is now selling digital tickets are integrated within the patron's wristband, thus providing an easy transition for patrons to get used to the cashless environment. A primary advantage is that internet connectivity is not required to operate the system. The new system uses a local server and a dedicated WIFI™ network that allows for direct communication between the local server and the mobile devices. The local server receives the digital ticket information when they are attached to the wristband profile, then the mobile point of sale devices simply deduct the menu item assigned amount of digital tickets for that transaction. Further, the local server pushes the schedule of digital tickets and the wristbands they have been assigned to the mobile devices frequently meaning that even if the WIFI™ was unplugged or went down for a period of time, the mobile devices can continue to accept digital tickets which is not only operating on a closed loop system it is operating offline the entire time with no need for internet.

The invention also generally refers to a security apparatus integrated with a ticketing and payment system. Another important feature is use of a logo image that has data embedded within it so that it can be used as a unique identifier, particularly a QR Code.

Applications of the platform include sporting events, concert venues or live music performances, parties or raves, transportation services, and general services. The primary application of the platform encompasses payment and purchasing of goods and services.

An important capability of the system is that it is redundantly designed to allow ticket and/or payment functions to proceed even if one or more communication mechanisms or protocols are offline, or not operating as expected. In one embodiment, the system is designed to continue to operate when the client device and/or the user device is no longer capable of communicating with the remote server managing user profile information and/or the ticket management system managing ticket credentials. In some embodiments, the proximal communication system continues to operate to allow the transmission of data between a user device and a client device even if a connection to a remote server or connection to the cloud is unavailable or offline.

In another embodiment a button on a primary or secondary device can be pressed, or the secondary device tapped to the primary, to view a balance associated with the user payment means stored in the user account system. Similarly, the primary or secondary device of a user can be present to a designated client device to automatically view a user account balance on the primary or secondary device.

The application will be capable of an all-in-one solution for events or venues. The account management system is identified in FIG. 1 as a user account system. Use of the user account system and interaction therewith is shown in FIG. 4.

The application will contain a ticketing platform, a patron ticket place holder, point of sale system (POS) or other payment receiving device, and an access scanner, all of which can be downloaded to any Apple or Android mobile device including iPads, tablets and smart watches.

The application is built on a operational system that includes an operating server, a payment process server, and a ticketing system, and/or a combination thereof. This is typically referred to as the platform or application.

The system includes a ticketing management system, as shown in FIG. 1, which may be operated and managed a third party. Use of the ticketing management system and interaction therewith is shown in FIG. 4.

A user or patron must engage the system shown in FIG. 1. using a portal and/or platform when desiring to take advantage of its numerous features. Operation of the platform is schematically incorporated within FIG. 4.

In a preferred embodiment represented by FIG. 4, the user or patron buys ticket online via a web interface or portal, and subsequently downloads and installs the application or platform on the user's mobile device, to use and access the system to manage tickets and payments, for the first time. This process includes: Patron accesses ticket purchase web portal; Patron selects ticket(s); Patron selects checkout; Payment web portal page appears; Patron enters fields required for payment; Patron adds a PIN number within the payment page or when the ticket is delivered to the application within the application; Patron accepts terms & conditions; Screen appears to confirm success and advises that an email has been sent with ticket(s); Email is delivered to Patron with instructions and a link to download the application; Patron uses mobile device to access email and clicks on the link; Link directs mobile device to application store to download application; Patron installs application; Patron opens application and the ticket(s) appear within the place holder of the application; Application has option to change payment source, or opt out, as the one used for ticket purchase has been automatically assigned, if selected Patron may use the application to take a picture of alternative card to attach for payment; Patron is now ready to arrive at event and gain access and use ticket within the place holder for on-site purchases.

If a user or patron has purchased multiple tickets: Patron will select additional ticket(s) and transfer to friend(s); Patron identifies application user name of friend or if friend has not used application before Patron enters email address of friend; Email is sent to friend with link and instructions; Friend clicks on link which directs him to application in the application store to download; Friend accepts terms & conditions adds a PIN number in case of lost, damaged or stolen phone; Friend installs application and ticket appears within the place holder of the application; Application requests friend to attach payment source; Friend uses the application to take a picture of card, enters any additional info or opts out; Friend is now ready to arrive at event and gain access and use ticket within the place holder for on-site purchases (if not opted out). If Patron already has the application, tickets may be able to be purchased directly through the application, once purchase is confirmed, the ticket will appear within the place holder within the application.

White labeling support for ticket companies is integrated throughout the design. If the invention is licensed to a client, the client's existing application will be able to plug into the present invention's application platform through the robust Application Programming Interface (API), and allow for complete white labeling. Additionally, in some preferred embodiments the application platform can be layered with multiple designs or skins corresponding to various events or venues. In a preferred embodiment, the application platform will automatically update to reflect the particular event or venue corresponding to the user's location, and/or a set time according to the user's ticketing credentials. This adaptive white-labeling system can also provide the user with an updated menu corresponding to the new event, venue, or time via the application platform, and such a menu and graphics associated with the new event, venue, or time would be visible on the user's device display automatically. In some embodiments the user can select a particular white-labeling interface based on certain parameters, choose whether to update the interface, and/or exit the current white-labeling offered.

The overall ticketing and payment systems, and its platform or application, allows a client to sell tickets to users for the client's event or venue. The client can select its pricing package depending on the amount of proposed tickets, and connect the ticketing to social media for advertising, or send notification through email or other forms of electronic transmission for advertising/marketing. The tickets are sold, and the funds are processed through the secured payment processing platform. The ticketing fee is set off against the ticket sale balance and the remaining funds are delivered to the client's selected bank account. There will also be options to provide a live dashboard that will contain both ticket sales and ticket inventory live information, and further to provide demographic information of the patrons relating to their purchases post event, flight etc, targeting marketing will also be an option to provide within the application;

The client will have the option to use the POS part of the application for selling items, and will be able to customize the menu/buttons on the POS register. The client will enter the description and price for each item it wants to sell, it may also have the option to take a picture or upload an image of each item and assign the applicable price. Another feature will be to permit the client to input how many units of each item are available for sale, and upon each sale the inventory list will be updated (scanning of barcodes or alternate codes and entering the what each code represents will be an option, which will stream line inputting larger inventories). There will also be an option to provide a live dashboard that will contain both sales and inventory live information;

Once the event is set up as in the previously described steps, the application is ready to manage the event. The client's staff will be able to select which function they will be performing (this can also have a PIN assigned or other authorization method to control who is authorized to use any given function).

The device may be a mobile device as outlined herein or similarly described throughout the specification and/or claims. More specifically, the mobile device is a mobile computing device such as a smartphone, mobile phone, PDA, or cellphone. The present invention typically applies to mobile smartphones having hardware and software. Hardware includes inter alia: a housing, a processor, a display, a GUI (often designated in throughout the specification and/or claims to refer to the user's Graphical User Interface (GUI) or the client's Graphical User interface—adjusted as Graphical Client (GCI), a transceiver and/or antenna, and a camera. Software includes inter alia: an operating system capable of downloading mobile applications and/or platforms and subsequently installing and executing these applications. The software is capable of connecting to a mobile data communication system, commonly referred to as a wireless or cellular provider. Similarly the mobile operating system software is capable of connecting to a local wireless communication system such as WiFi. Known operating systems of mobile devices include Apple's iOS, Google's Android mobile software versions, Windows mobile, and blackberry, inter alia. Any device that is equipped with a camera will be able to function as an access scanner or a POS terminal, where by the application will cause the device to scan a ticket to either validate the ticket for access or to accept payment from the ticket code at the POS.

The device is arranged to function as a ticket and payment system. The device as a payment system functions as stored value card, or as a gift card, or as a debit or credit card linked to an established account at a financial institution, or a member's account. It can also allow the device to function as a ticket for entry to a concert or other event, or to a particular seat or area, such as at a VIP enclosure, within the event.

Importantly, the hardware and/or software also provides a proximal or short-range communication capability, to include wireless signal receiving and/or transmission, and displaying a data embedded image (DEI) on the GUI of the device. The proximal wireless communication methods are usually described as protocols that allow wireless data transfers between two or more mobile devices over short distances, usually at least within visual site of one another.

In one embodiment, the overall system at least makes use of a graphical system using a DEI as at least one proximal communication system. Such DEI protocols or designs include inter alia: Proximal communication systems managed or engaged by the inventive system described herein include inter alia: machine-readable code, barcode, 2-D barcode, Quick Response (QR) code, a data embedded image (DEI), a data embedded image (DEO), a Graphical User Interface (GUI), a Graphical Client Interface (GCI), and any other wireless form of textual or graphical communication. In one embodiment example, a barcode is displayed within the platform application, or is applied to the exterior of a bracelet to be used for communications purposes, such as access control and payment applications described herein.

In another important embodiment, the overall system uses at least one proximal communication system operated by the devices, the proximal communication system comprising a wireless protocol defining or managing the transmission, or sending and receiving of wireless signals that enable the transfer of data between two or more devices. Such proximal wireless system or protocols include inter alia: a Near Field Communication (NFC) means; a Bluetooth means; a Bluetooth Low Energy (BLE) means; an audible or inaudible sound or frequency; an ultrasonic signal transmission; a Radio Frequency Identification (RFID) means; a WiFi means, and any other wireless form of wireless signal-based communication.

The device is usually designated throughout the specification and claims as either a client device possessed and operated by a client (the company or individual responsible for the event or venue, that acting as an inviter offered or sold a ticket to customer, the user), or a user device possessed and operated by a user (the customer acting as the invitee who purchased a ticket to the client's event or venue, and seeks to obtain access and purchases at the event or venue). FIG. 1 schematically shows the incorporation of these devices within the overall system as designated by a user device and a cl Figure ient device. The operation of these devices within the overall ticketing and payment system is schematically shown in FIG. 4.

An important feature of the present invention is that the client device and the user device, may be copies of one another; they may be the same make and model of a mobile device, or the user device may be similar in form and/or function to the client mobile device. The user device and the client device may be interchangeable. This is possible because both the user and the client device will contain or have access to the same or similar platform or application, which they will open and run to engage the system and perform ticketing and payment functions.

Accordingly, the system allows a user's mobile device to operate as a ticket and mobile payment all in one. On the other hand, the system allows a client's mobile device to operate as a terminal, gate, access point, POS, benefit station, turn-style, and ticket taker.

Another important feature with respect to the system and its platform installed on the user's device, is the application or platform on the user's mobile device will allow a user to access a customized menu displaying goods or services, offered by vendors at the event or venue. For example, a user would desire to attend a Los Angeles (LA) Lakers game; the user would then introduce himself/herself to the system by accessing the web interface via a computer or mobile device (in which case the user may have installed an application allowing this), and sign up for an account. When signing up for the account, the user can add or associate a payment means (e.g. bank account, credit account, credit card, and/or cryptocurency) with the users/account that allows the user to initially purchase at least one LA Lakers ticket, after browsing and selecting at least one seat. The entered payment means is associated with the user's account, which allows the user to subsequently purchase or obtain goods, services, and/or benefits at the Staples Center, which is the venue for the LA Lakers. Such purchases can be executed at a terminal or POS at the Staples Center, such as at a concession counter or stand in the concourse offering food and beverages, including alcohol beverages. Or the system and platform application on the user's mobile device can be used to make a purchase for apparel at the Lakers on-site sporting goods store, for example, at a POS within the store. Alternatively, the user could access all, or a portion, of the entire offering of the client and its vendors, via the application on the user's device at the user's current location, without having to walk to a POS, terminal, or kiosk. This would allow a user to order a beverage, for example from his/her seat using a customized food and beverage menu offered to the user via the display and GUI, or the user device as determined by the client. The user would make his/her selection within the application platform, and the payment means previously set by the user would be debited or charged appropriately, and the good, service, or benefit, in this case a beverage, would be processed and filled by the vendor (on behalf of the client), and then delivered to the user's current location based on the user's ticketing information, and/or location information provided by the user's mobile device or tracked by the client.

The User could also automatically set his/her device, and/or account, to enable the purchase of restricted food or beverages, such as alcohol, the sale of which is restricted to persons of legal drinking age. Under this scenario, the user at the time of account signup or ticket purchase using a web interface, or subsequent thereto using the application or platform via the user's mobile device, can ask the system to authenticate the user as a user of legal drinking age, allowed to purchase alcohol or beer at events or venues. This could be accomplished by the user inputting necessary information, or data from the user's driver license or Identification (ID) card or passport, or similar official document, collectively referred hereafter as ID, meaning any of these types.

In a preferred embodiment, the system allows the user to present his/her ID to a sensor or interface component such as a camera. This would usually work with the camera on the user's device. Essentially the user could operate the application installed on the user's device and would navigate to an age verification portion produced by the application and displayed via the GUI. The user would then authorize the application to allow use of the user's camera on the user's mobile device, if the user has not already done so, and the user would take a picture or snapshot of the front and/or back of his/her ID. The system would analyze the picture of the ID and extract textual and/or graphical information including any barcodes or other codes provided on either side of the ID. The system would then communicate at least some of the extracted ID information, typically a barcode and/or date of birth (DOB), with a known verification or authentication database, often provided by an official authority or government entity, to verify and authenticate the user as a user of legal drinking age. Alternatively, this verification and authentication could also be performed using a client device, and/or official designated by the client at the event or venue, at a designated area (e.g. ID tent or desk), at a terminal, at a kiosk, and/or at a POS (e.g. a cash register at a concessions stand that sells beer). This on-site verification could be automatically performed using the camera on the client's device, and/or could be performed by a manual check or verification of the user's ID, and a subsequent permission entered into the system or update thereof.

Under any of these circumstances, after the user has been verified or authenticated as a user of legal drinking age, the user's mobile device would thereafter also serve as a status identifier indicating legal drinking age. This would take the place of a wristband or stamp traditionally provided by events or venues designating the user to be legal drinking age. Similarly, these capabilities could also be used to appropriately designate a user as a minor or one that is of non-legal drinking age.

In a similar manor to the designation of legal drinking age, the customized menu feature provided on a user's device would also include offering status upgrades or additional privileges associated with a ticket of the user, including access privileges or status privileges such as a Very Important Person (VIP) status designation as desired.

Any Android or Apple device that is equipped with a camera will be able to function as an access scanner or a POS terminal, where by the application will cause the device to scan a Patron's ticket to either validate the ticket for access, or to accept payment from the ticket code at the POS.

In some embodiments, the ticketing and payment system can allow or incorporate secondary or accessory devices. Essentially a user would have a primary user device, typically the user's smartphone associated with the user's account and ticketing information. The user could also possess and operate a secondary device such as a wristband, a smartwatch, or RFID tag, or similar accessory, in the same way the primary mobile device or smartphone is used. This allows the user the added benefit of performing access and payment functions even if the user's primary device is unavailable or inoperable. For example, the user's device could be powered off because of a low or dead battery. In an embodiment incorporating secondary devices such as smartwatches or wristbands, various features and/or data can be activated on the wristband, and/or transferred back and forth between the primary device and the secondary device.

In some embodiments the system can be accessed using an online or networked device or the application platform installed on any mobile device, in order to access a particular user's account and manage the operation and acceptability of a user's primary and secondary devices. Accordingly, various primary and secondary devices may be activated by the platform operable on a user and/or client device. In some embodiments, both a primary device and a secondary device can be activated and identified as acceptable proximal communication devices, within the system for authenticating and validating the user, ticketing credentials, and/or payments.

Companies such as Proximities (recently acquired by Bartronics America) and Precision Dynamics (PDC) have developed alternatives to using the conventional paper ticket for access to venues such as water parks and amusement parks. These solutions focus mainly on offering convenience to guests and reducing ticket fraud by providing non-transferable and non-reusable RFID-enabled bracelets for access control and other applications, such as point of sales (POS) purchases at places such as amusement parks, hospitals and ski resorts.

Previous alternative paper ticket solutions are closed loop systems, focused on providing access control and payment solutions for a particular operator, and typically for just one physical location managed or operated by that single operator. For example Proximities' preferred solution has been to provide a single client with barcode or RFID-enabled bracelets to replace paper tickets, that can be used by patrons as an admissions ticket, and as a payment option, which presumably adds convenience for guests, and fraud prevention for the amusement park operator. Proximities' U.S. Pat. No. 7,042,357 discloses an RFID-enabled bracelet ticket is contemplated that deactivates the access privileges and payment application when taken off the wrist of the original purchaser to combat fraud stemming from the unscrupulous practice of transferring an admission ticket to someone who never paid for admission to the amusement park. Deactivating the bracelet and making it impossible to transfer or reuse once the bracelet is taken off the wrist, clearly is a desirable solution for the operator of the amusement park, who loses money each time guests share their admissions ticket with friends and family, who may not have paid for access privileges. In this closed loop system, the RFID-enabled bracelet itself has no value or practical usefulness once it is taken off the wrist, and cannot be used outside of the venue or event for which it was designed. Proximities' non-reusable bracelet event tickets are good for use only at a single venue and therefore are not reusable or functional at other events or venues.

The present invention uses a barcode and/or RFID-enabled ticket, or pass containing data identifying the patron, as a device that event patrons use for POS payments, and admission to events. The ticket may conveniently be in the form of a wrist bracelet that the user can wear to the event or venue, but, as will be readily apparent to those skilled in the art, the barcode or RFID-enabled device could take many forms, including a card, similar to a conventional credit card, a key fob, RFID sticker or a souvenir or promotional item. In one form of the invention, the identity data is transmitted to the patron's cell phone or other PDA and can be displayed on the cell phone screen or transmitted by the cell phone. The term “pass” as used in this specification and claims is to be understood to include these alternative forms of platform for the barcode or RFID device.

Alternatively, if a Patron's phone is lost, stolen, damaged or dies, a Patron can attend costumer service desk to obtain a paper replacement ticket, or other secondary device with proximal communication capabilities, that can be used for access and cashless purchases, the PIN previously selected by Patron within the ticket purchase or use of application will be required to be entered with every purchase.

The present invention in its preferred embodiment envisions using a first smartphone as the user mobile device, and a second smartphone as the client mobile. In a preferred embodiment the first smartphone is substantially similar to the second smartphone in form and function, to maximize compatibility between the user and client device. In other embodiments, the system can incorporate a secondary electronic tag and/or RFID-enabled bracelet as the pass or electronic ticket, and mobile payment. In addition to user's smartphone. In other embodiments, the system may incorporate or allow other device forms for this purpose including, but not limited to, a smart card, badge, key fob, RFID stickers (such as Go-Tags manufactured by First Data), a bracelet, a necklace, apparel, a personal digital assistant, or other device that has proximal communication technology built in such as RFID or NFC. As long as the RFID chip and/or barcode, other data housed within or on the user device, or user pass can communicate with the client readers at the events. and to access a user's account profile and associated privileges in the account and/or ticketing system, the form of the ticketing and payment device used for such purposes is secondary.

In some embodiments, the data could even be in the form of a barcode printed on the exterior of a paper pass or ticket or electronic device, e.g. the bracelet ticket. In an alternative form of delivery, not shown, the account identity-identifying data is delivered to the patron online to the patron's computer for printing, or to another suitable device, such as a cell phone or personal digital assistant (“FDA”), to be readable when displayed on the device's screen, or to be transmitted by the phone or PDA.

If the user mobile device is to be used in a live event setting, for example, the information stored in the system and associated with the unique information stored on the user mobile device may include: age verification or special access privileges to allow access to age-restricted areas, a credit/debit account balance for payment of food and drink, parking privileges, and identification of the patron's favorite drink to facilitate placing orders in loud, crowded areas. It can also allow the user mobile device to function as a ticket for entry to a concert or other event, or to a particular seat or area, such as at a VIP enclosure, within the event. The user mobile device itself, because of the encoded identity linked to the account record in the system data, can function as a proof of purchase, and as a wearable ‘ticket’ that allows the wearer to enter and exit the event, or restricted areas in the event. In an alternative form of the invention some data, in addition to the unique identification data, is stored on the user mobile device to be read at the event location. This could include stored funds.

Additional features and capabilities of the system include inter alia: Obtaining user profile information from a driver's license image, and Atomically Validating drinking age via driver's license image and updating associated access]; API & Obtaining user profile information from a third party; Pushing customized event menus to mobile device; Pushing event offers including notifications and benefits.

When the user mobile device or bracelet includes a transponder chip or hardware capable of operating various proximal communication protocols, the user mobile device or bracelet may also function as a tracking device for children, the physically or mentally disabled and senior citizens attending the event who may suffer from a disease such as Alzheimer's. Similarly the system can be used in a medical setting to provide patient identifying information or chart history. This information can include allergies, medical conditions, and/or emergency contact information.

Accordingly, another important capability the system provides that is frequently desired by clients, is the ability to provide subsequent or real-time tracking of a user's location and access and purchase history. This collection of data is performed automatically by the system and/or its platform, when the platform is installed or accessed or operated on the user's device. The system will record various actions performed by the user within the system. The data will be aggregated and analyzed for all users, and provided in multiple useful formats to the client for marketing and future planning purposes. This will allow the client, and/or the user, to monitor what goods, services, and/or benefits were obtained and associated costs including total costs and costs broken down according to various categories.

The tracking features of the system are particularly useful at a tradeshow, since they will allow the client and user to provide and access a customized menu for goods and services based on the user's location. The customized menu will be presented via the application or platform GUI of the user's device. Furthermore, in some embodiments, such as at a tradeshow, all or part of the user's personal information or contact information can be automatically or selectively provided, depending on times and locations of the user. In a preferred embodiment, the user, via the platform, can set the personal contact information capabilities and parameters.

In a further aspect of the present invention, combining the universal ticketing function with the payment application, the present invention also offers significant value for advertisers and corporate sponsors of live events. Currently there is no system in place that provides data linking transactions at live events back to a specific individual spectator. There is, of course, a large amount of general demographic information on spectators that attend particular events, such as the Super Bowl, that advertising agencies and corporate sponsors like Budweiser use on a regular basis to make marketing decisions, and budget ad spends; however, this current demographic information is incomplete because it answers only in general terms of what types of people attend an event. It cannot answer the most important question: What is the individual John Smith buying at these live events? By combining the event ticketing application with the payment functionality onto one universal mobile device or bracelet ticket device, every transaction at every event across a network of live events can be traced back to a specific individual's mobile device or pass account. And that would offer an incredible amount of extremely valuable business intelligence information beyond the general demographic info currently available to advertisers and corporate sponsors.

In some embodiments, the appropriate server stores all data related to purchases made by each user with an account, and can analyze all transactions using analytics software, known in the data mining field, and produces data that can be used for behavioral marketing and promotional campaigns encompassing statistical measurements, such as demographic information, brand preferences, purchase history, events attended, average spend per event and the like.

In some embodiments, at the discretion of the client acting as an event producer, a separate event access location or lane, similar to a fast lane or express lane, can be offered to account holders and/or users of the mobile electronic ticket and payment system, to provide these users with expedited access to the event, as an added benefit to the fan for signing up and using the system described.

In a preferred embodiment, the user mobile device is authenticated and/or activated by the user downloading a platform application to the user mobile device, and logging in to access his/her account, for ticketless access and mobile payments associated with his/her user account. After or upon signing up and/or creating a user account, a user acting as a fan can purchase an event ticket on an appropriately linked website, and/or within the mobile application platform downloaded and installed on the user device.

In some embodiments the user account system will generate a message or notification electronically transmitted to the user. This includes a message or notification delivered to the user mobile device via email, SMS message, digital message, text message, and/or a notification or message displayed via the application platform, downloaded and installed by the user on the user's device. In some embodiments, the message or notification is emailed to the email address, and/or texted, or digitally transmitted to the mobile phone number associated with the user account. In some embodiments, the notification or message can also include a hyperlink to display a confirmation and/or a purchased ticket, or associate proximal communication image. In some embodiments the message or notification contains a hyperlink allowing the user to download and install the application platform necessary to interface with the system and receiver, and/or display an associated ticket and/or confirmation. In some embodiments, access and/or purchase confirmations can be transmitted to the user mobile device using similar means and methods.

In some embodiments, the fan can then go to the event and use his user mobile device, or pass, for expedited parking access and expedited VIP access, using a preferred access lane or point of entry for account holders using the mobile electronic ticketing and payment system described. The fan can also use his/her user device to make contactless transactions at concessions stands and gift shops, by interacting with an appropriate client device operating as a POS.

Accordingly, in some embodiments the user account system tracks all ticketless access and POS transactions, and appropriate analytics software mines the data for use in targeted marketing and promotions, which may include offering discounts to users on concessions, event tickets, downloadable music, merchandise, and sponsors' goods and services. In some embodiments, targeted marketing and promotions can be delivered using the user account system, to the fans via email campaigns, on a mobile phone, or other mobile devices and when the fan logs into his account using the mobile platform on his/her mobile user device, or when accessing an appropriate website using his/her mobile device, or other device, computer, tablet, or laptop.

At any time, the system can obtain information from the system about purchase transactions performed by patrons using the system. Moreover, using conventional data mining techniques, the data contained in the system can be analyzed, for example, to analyze purchases of events, or goods in accordance with demographic information obtained from patrons during the establishment of the patron's account. By mining the data of individual transactions on the account, one can analyze the spending habits and brand preferences of users having accounts. Sponsors of events can then market to both individuals and particular segments of the population, deemed target customers that fit a certain profile i.e. demographics, household income, male or female, type of live events attending (rock or country) etc.

In some embodiments, the application platform can be used to transfer a ticket credential from one user to another. In some embodiments, the application platform can also be used to execute a payment between one user with a first user device, and a second user with a second user device. In such embodiments, the system can transfer a payment means from one user to another, or a set amount of funding or money from one user to another. In some embodiments, such a payment transfer design can require both users to have an account, and have the application platform installed on his/her respective user mobile device, to transfer and/or receive payment. In a preferred embodiment, a first user can send a ticket or payment credential to a second user, along with a message or notification that the second user must sign up for an account, and/or download and install the application platform, in order to view, access, and/or use the transferred ticket or payment credential.

In one embodiment of the system's transfer capabilities, the user device and/or a user's banking account username and password, is used to verify the transferee receiving payment or money, and transfer the money to the proper account; typically a banking or credit account managed by a financial institution, but could also include a cryptocurrency account or a shopping account in the form of credit like Amazon.

In some embodiments, the platform for can be designed to allow the user to set various parameters, or customize ticket or status application or payments or other benefits. In a preferred embodiment, a user can designate a tip amount or percentage to be added to all transactions, so that every time a user executes a POS transaction, the tip amount is automatically applied.

Furthermore, because the system uses a platform application design, wherein the tip would be designated by accessing the user account, the tip would be applied when the user presents his primary device (e.g. smartphone), and/or secondary device (e.g. smartwatch or wristband). Any changes made by the user to customizable parameters would automatically be pushed to any and all user devices, and/or client devices. In another embodiment the user would be able to select an option whereby the user enters a tip amount at each POS transaction, using either a user device or client device.

While use of the invention is primarily discussed in the context of live events, the system can be employed in various other scenarios where provision of a limited access resource, and mobile payment would be advantageous. In one embodiment, the system is designed and deployed to govern a public transportation system, including management of metrorail, rail, train, van, bus, and/or plane tickets and purchases made within such a system.

In another embodiment, the system can be deployed during or immediately following a natural disaster, to allow the distribution or rationing of goods or services to designated users authorized to receive aid. Such distribution may or may not require a financial transaction. For instance, the government may want to restrict a debit account to particular goods or services. After a hurricane for example, the government could deploy the system so that users in a particular geographic area receive a government sponsored debit account, but wherein such an aid account is restricted to purchasing blankets, food, water, or other disaster aid type goods or services. In such a government use embodiment, the system could allow the government or aid supplying entity to track users, and or the purchases they make, for various reasons.

Illustrated in FIG. 1 is a system and method to authenticate a device and securely transfer and receive data between the device, and an additional device, and/or between multiple devices capable of interconnecting within the system. Both the device and additional device may be part of a network, and at least one of the devices may include a coil and be capable of inductive charging and data transfer via a power channel and an inductive link.

The data may be transported over some transport medium including: WiFi, System of Mobile (GSM) communication system, a Code Division Multiple Access (CDMA system), a Universal Mobile Telecommunications System (UNITS), OF some other suitable transport medium.

Illustrated in FIG. 3 is a system and method to authenticate a device, used to transfer and receive data, to an additional device, where authentication takes the form of placing the device in proximity to the additional device. The proximal communication system protocols designed and operated may or may not require a WiFi and/or a mobile data network connection and/or a connection to the global communication system.

The use of DEI or proximal wireless communication technology, e.g. NFC or RFID via an appropriate transponder RFID chip, allows the client, in the capacity as an organizer of an event, to scan people for admittance quickly and conveniently, much reducing the time taken to process people arriving for an event.

A proximal wireless communication system is an important component of the global communication system of the overall system for ticketing and mobile payment. The proximal wireless communication system is short-range communication system that does not require any wires connected between two or more devices to allow communication therebetween. The proximal wireless communication system comprises a proximal or short-range communication capability that includes wireless signal receiving and/or transmission and/or displaying a data embedded image (DEI) on the GUI of the device. The proximal wireless communication methods are usually described as protocols that allow wireless data transfers between two or more mobile devices over short distances, usually at least within visual site of one another, with or without a physical contact or touching existing between the two devices.

In one embodiment, the overall system at least makes use of a graphical system using a DEI as at least one proximal communication system. Such DEI protocols or designs include inter alia: Proximal communication systems managed or engaged by the inventive system described herein include inter alia: machine-readable code, barcode, 2-D barcode, 3-D barcode or image, a hologram, a Quick Response (QR) code, a data embedded image (DEI), a data embedded image (DEO), a Graphical User Interface (GUI), a Graphical Client Interface (GCI), and any other wireless form of textual or graphical communication.

In another important embodiment, the overall system uses at least one proximal communication system comprising a wireless protocol defining or managing the transmission or sending and receiving of wireless signals that enable the transfer of data between two or more devices. Such proximal wireless stemmer or protocols include inter alia: a Near Field Communication (NFC) means; a Bluetooth means; a Bluetooth Low Energy (BLE) means; an audible or inaudible sound or frequency; an ultrasonic signal transmission; a Radio Frequency Identification (RFID) means; a WiFi means, and any other wireless form of wireless signal-based communication. In some embodiments, proximate may be within a range of 0-4 cm. In some embodiments the authentication may take place over a low-range-transport medium that includes: the inductive link, RFID, BLUETOOTH™, or some other suitable transport medium.

In a preferred embodiment, the proximal wireless communication system includes both at least one graphical capability and at least one short-range wireless signal capability. Ideally, to allow maximum capabilities and compatibility between devices, one would desire that the client device and the user device include hardware and/or software allowing transmission/sending and receiving using all of the major graphical and wireless signal protocols. More importantly, a preferred embodiment is designed so that the client device operated or provided within the overall ticketing and payment system is outfitted, via its corresponding hardware and software, with all of the most common graphical and wireless signal proximal communication protocols and their capabilities. This would allow maximum capability with a predefined client device to communicate proximally with a wide-range of user devices having more limited proximal communication means, i.e. thereby enabling a client to provide users with a system having maximum compatibility.

Furthermore, a preferred embodiment is designed to all the proximal communication system to engage and establish connections amongst multiple user devices, simultaneously from a single client device. A preferred embodiment also includes proximal wireless communication design allowing the client device to connect to user the device using multiple wireless protocols simultaneously.

Within this design of simultaneous connection over multiple protocols between a client device and a user device, the proximal wireless communication system would actively detect and wireless monitor signal and graphical communication means to determine optimal connections to establish based on diagnostics and accordingly transmit data over two or more connected protocols that have been determined to be optimal in order to speed up overall transaction or engagement times and associate data transfers between devices. An additional benefit of such simultaneous connection and data transferring amongst multiple protocols is that this design allows the overall system to more efficiently distribute its load in terms of processing and storage over multiple communication systems based on environmental parameters and historical use of the system.

Furthermore, this proximal wireless communication system design provides an automatic built in redundancy that ensures continuous operation of the proximal wireless communication system in case one or more protocols are inoperable or go down because of unexpected events, network errors, power outages, and/or communication system or provider outages. That way client devices will still be able to communicate with user devices under almost any circumstance to thereby allow users to access the event or venue and make purchases therein.

In some example embodiments, a mobile computing device is proximate to an additional device such that the mobile computing device is authenticated to the additional device (“A”). This mobile computing device may be brought proximate to a further device (“B”) such that the mobile computing device is authenticated to “B”. The mobile computing device is able to transmit and receive data between “A” and “B”, based upon its being authenticated to both “A” and “B”.

In some example embodiments, the authentication of the mobile computing device to “A” and “B” may cease where the mobile computing device is no longer proximate to “A” or “B”.

For example, if the mobile computing device is removed from proximity to “A”, then the mobile computing, device may no longer be authenticated to “A”, Similarly, if the mobile computing device is no longer within range of the “A” to use one of the above referenced transport mediums, the mobile computing device may no longer be authenticated to “A”. The use of the range of the mobile computing device to “A” as a basis for continuing authentication may be referred to herein as non-persistent authentication. In some cases, a mobile computing device may have persistent authentication wherein once the mobile computing device is authenticated to “A”, it continues to be authenticated irrespective of its proximity or range to “A”.

Aspects of the present disclosure provide systems, methods, and computer program products which can be used in any context where a purchase/payment transaction is consummated using direct communication between a consumer utilizing a proximal communications protocol (e.g NFC, RFID, Bluetooth, WiFi, etc.) via an appropriately enabled mobile device (e.g., a smartphone) and a central server, wherein the delivery of goods or services to the consumer is gated at a later time by a validator device, such as a checkout terminal, turnstile or other gating device or mechanism having an a proximal communications reader, that receives a communication from a user or client mobile device. Such aspects eliminate the need for consumers to carry traditional (plastic) or contactless credit/charge/pre-paid/stored-value cards.

Aspects of the present disclosure provide systems, methods, and computer program products that eliminate the need for contactless purchase/payment systems to rely on card emulation normally requiring access to a mobile telephone's secure element for which access is restricted and dependency on OEMs or network service providers to provide access to the secure element.

In other aspects of the present disclosure, the systems, methods and computer program products provided, address the possibility of a mobile device being replicated after a purchase is transacted with a server. That is, there may be instances where unauthorized persons replicate (clone) the memory of a consumer's mobile device onto another mobile device. In such instances, both mobile devices could conceivably be used to simultaneously defeat any system that leverages remote validator devices that are not in real-time communication with each other or with a central server. The present disclosure thus limits the duration between the mobile device's request for a token and the time by which the token expires or must be used. By limiting this amount of time, the amount of time during which a device memory could be replicated is also limited, and risk of fraud is thereby attenuated.

In another aspect of the present disclosure, the systems, methods and computer program products provided incorporate mutual (i.e., two-way) validation between each of the consumers' mobile devices and any validator device with which they come into NFC communication. That is, the validator device can validate the mobile device and the mobile device can also, in turn, validate the validator device.

In another embodiment, the DEI communication capabilities of the system can use a graphical image corresponding to the client's event or venue and/or a particular product or service provided by the client, including a textual name or trademark and/or a graphical log or trademark.

In a preferred embodiment the proximal communication system can display a preselected or predefined image automatically determined by the system or chosen by the client that is visually displayed via the user's GUI on the user device to thereby authenticate the user upon visual inspection by the client at an access point and/or POS. This image can also be designed to incorporate a machine readable code such as a barcode or QR-Code. The incorporation of a machine-readable code is not required, however.

In one embodiment, the system uses at least one wireless signal protocol to exchange data between the user device and the client device for verification and/or authentication of the user and/or the user's ticket or credentials. If the system determines the user allowed or accepted (e.g. with respect to access or payment), the system can return and display a designated graphical and/or textual image on the user and/or client device to provide a quick visual verifying means to the client and/or user. Similarly, a decline, rejection, or denial determination can be similarly transmitted and displayed on the user and/or client device as a graphic and/or textual image as appropriate.

The proximal wireless system can include an audible or inaudible or ultrasonic sound or frequency transmission or receipt among one or more devices as a way to exchange data and/or authenticate or verify a user and user device and any corresponding credentials. In preferred embodiment such a frequency/sound based transmission system would incorporate at least one additional proximal communication protocol.

Radio frequency identification, or RFID, is a generic term for technologies that use radio waves to automatically identify people or objects. There are several methods of identification, but the most common is to store a serial number that identifies a person or object, and perhaps other information, on a microchip that is attached to an antenna (the chip and the antenna together are called an RFID transponder or an RFID tag). The antenna enables the chip to transmit the identification information to a reader. The reader converts the radio waves reflected back from the RFID tag into digital information that can then be passed on to computers that can make use of it.

The proximal communication means, e.g. RFID transponder chip device, is housed within the user mobile device and client mobile device and can also be housed within an accessory device such as a bracelet ticket. In some embodiments the user mobile device operates a platform that contains a barcode and/or a RFID-enabled device that enables data to be stored and retrieved, transforming the user mobile device into a communications device and allowing it to function as a wearable event ticket and as a payment device, obviating the need for a paper ticket or separate money card.

Preferably, the information is stored on the user mobile device by means of a contactless device receiving and transmitting data by, any proximal communication system as described herein, such as NFC, Bluetooth, RFID, sound or frequency, DEI, QR Code, etc. In preferred embodiment, the user and client devices include all necessary chips and communication hardware to identify and transfer data over the most common proximal communication protocols. In one embodiment the devices incorporated within the system include the passive RFID chip technology typically incorporated in smartphones or RFID tags or s. In operation, the patron uses the user mobile device in the same manner in which conventional RFID user mobile devices are used. The user mobile device is possessed by the user in the user's pocket or bag etc. or in the case of an accessory such as a wristband, the device attached to the wrist or other body part of the patron and then, when unique identification is necessary, the user must bring the user produces the appropriate device (e.g. user mobile smartphone or electronic bracelet) within a certain distance of an proximal communication reader (the “read range”) of the client device (e.g. mobile smartphone, terminal, POS, kiosk, etc.), which transmits a wireless signal. When within that distance, the proximal communication chip or similar transmitting and/or receiving hardware will be powered by the wireless signal from the reader (the client device) and, in response, transmit to the client device acting as a reader its own wireless signal representative of the unique information pre-stored or pre-programmed in the appropriate chip or machine readable medium of the user device. The client device usually comprises a microprocessor having a database of relevant information pertaining to the unique user mobile device identification, or that communicates with the pass network database or is appropriately linked to such a microprocessor, and/or database, via a global communication system or network, typically housed by a server within the system.

In one embodiment, the proximal wireless communication system allows simplex communication between the user device and the client device. Simplex communication is represented by a one-way or unidirectional transmission of data. The unidirectional transfer of data can be transmitted from the user device and received by the client device. Alternatively, the unidirectional transfer of data can be transmitted from the client device and received by the user device.

In a preferred embodiment, the proximal communication system allows duplex communication between the user device and client device in addition to the aforementioned simplex communication. Duplex communication corresponds to a two-way or bidirectional transmission of data. A duplex communication system typically requires that the user device and the client device each have their own transceiver capable of sending and receiving signals according to a particular protocol.

In a preferred embodiment the simplex and/or duplex communication capabilities apply to each protocol out of a plurality of protocols offered, depending on the hardware and software design associated with each device and protocol. Accordingly, an intelligent proximal communication system can select at least one particular protocol and initiate either simplex or duplex communication between the user device and client device based on the environment, diagnostics, user hardware and software, and client hardware and software.

In some embodiments the transmission of data between the user device and the client device is governed by the client device. For instance, the client device and/or may authorize the unidirectional and/or bidirectional transfer of data or operation of the protocol to occur.

In some embodiments the communication signal will be characterized by a strength that only allows the signal to be received and/or identified by a secondary device, when both devices exist within close proximity of one another.

In many embodiments, the designation or provision of NFC and RFID protocols are considered to be interchangeable. Accordingly the software and/or hardware design necessitated by NFC and RFID protocols is similar or one design provides for both protocols automatically.

In a preferred embodiment the proximal communication system operates automatically without requiring user or client input. Accordingly, the proximal communication system continuously monitors (via the client device and/or the user device) the airways for particular signals and/or device signatures or handshakes or similar requests.

In another preferred embodiment, the proximal communication system requires a user and/or client to open the application platform on the respective user or client device. In some embodiments a command must also be executed by the user or client to send and/or receive a communication. For example, upon identifying an available protocol, the user GUI or client GCI may confirm that the user/client wants to operate the particular protocol in a particular fashion.

In a preferred embodiment an intelligent proximal communication system having multiple protocol capabilities or a layered protocol architecture provides a client with a convenient work-around design for operating all of the NFC capabilities of an Apple iPhone for instance with respect to either the user device or the client device. In some instances, the NFC capabilities of are intended by Apple to be restricted to only allow simplex communication between device when called upon by a particular application platform installed on a user device or a client device. In some embodiments this would mean that the system could effectively transmit data in a desired direction by repurposing a handshake function meant to identify another device. This intelligent proximal communication design and operation would allow an Apple iPhone's NFC communication system to be effectively used as a duplex communication protocol as necessary by repurposing signal identifying functions to be transfers of necessary data, either from the user device to the client device, and/or the client device to the user device. For instance, in some embodiments this would mean that the system could effectively transmit data by repurposing a handshake function meant to identify another device.

In a preferred embodiment associated with the Apple NFC work-around discussed above, the communications transmitted include validating a credential, issuing a payment, and/or performing any user action. This system would provide a work-around allowing the platform application to avoid using APPLE PAY and/or iTunes Concert Ticket that is intended to be forced upon users by Apple.

A preferred embodiment of the present invention represents an improvement over the data security design and methods disclosed by U.S. Pat. Nos. 9,055,438 and 9,239,993. Accordingly, in the present invention the security system is managed and operated by the application platform, which will have to communicate with a payment server initially, in order to tokenize the credit card information. Output comprises, or is a data stream containing one or more UIDs. A user inputs financial information, which is immediately sent to a payment server, payment server responds to application server with token, application server registers token with payment server, then generates its own unique ID. In one embodiment there is a UID for each payment means. In one embodiment UID for personal information remains on application server. In another embodiment, at least one UID is downloaded to application. In one embodiment multiple UIDS are linked together. The application server will have database that can look up corresponding information based on one UID. Application server uses token to create payment profile, payment server responds with UID for that payment profile.

The application will not need any communication with the application system. It only needs to communicate with server for ticket information. GUI will be updated by communicating with server to create “ticket”. Sign in or activates application, it will automatically contacts the server, then the server.

Security processes and capabilities include application with output, Login into application, Application server communication and stored data. Ticket is full place holder and the ticket comprises QR Code and application. As soon as user produces the QR Code, security protocol will initiate. Terminal enters order and prompt to scan, send information to application server, application server responds with yay or nay based on communication with payment server, respond with yes or no based on response from payment server.

Entry Point Application server will communicate ticketing system, and will respond appropriately to the terminal, terminal person says yes or no. Client application can receive indication in some embodiments. In other embodiments the client application does not receive any indication. In this instance the mobile device is an island and can only send information, it cannot receive it.

Application server has recorded that person has entered event, records a success that the ticket cannot be used again. Updates record for the ticket, which has a UID. Application will automatically have ticket. GUI will show ticket, ticket will; Application will use its unique ID. Output contains one or more UIDs to payment information. The UIDS allow the payment server to pull up appropriate payment information.

Sign up for account solely with personal information, UID is created within the application server or primary server, application server generates UID (account only). UID is built contain personal identification, UID that application server has assigned to that data, and a timestamp.

Output comprises at least one encrypted unique identifier. Receiving device transmits data. Credit card data is sent to financial payment server, payments server tokenizes, returns to client, clients application then send tokenized data to primary server, then primary server makes a record with payment server including the tokenized financial data. In one embodiment a QR code is used as a type of barcode. Generate QR code for payment when making a payment, QR code is generated.

In one embodiment a unique ID can be designed using an algorithm dependent on particular times or durations. The current time can be established by a user device, a client device, and/or the server. In some embodiments the time may include a tolerance allowing some variation from set times in case devices and/or systems are delayed or out of sync or if a calibration is required.

In some embodiments the unique ID is a simple timestamp synchronized to refresh to a new matching key at the same exact time as that of the server, and remain valid as such for a predefined duration. Such a system would require that the update rules and content match for both server and device, and this governing information could be retained on a the server and/or downloaded locally to the user device and/or client device.

In one embodiment the security system is described as dynamic local code. The application, locally, or an operational system or platform that it communicates with, will generate the ticket which will simultaneously contain information for both access and payment.

In one embodiment the security system is described as hybrid code. This approach will cause the ticket code to simultaneously contain information for both access and payment. The code generated from the ticket data base (ticketing platform including a 3rd party) will be delivered into the application. The application will maintain the ticket's credentials that are used for access but the application will alter the other parts of the code to include payment properties. At predetermined intervals, or after each purchase transaction, the application will discard the old code and create a new code that will maintain the original access credentials but will change the payment properties within the code for security reasons.

At predetermined intervals, or after each purchase transaction, the application will discard the old ticket code and create a new ticket code. Each time a new ticket code is created it will be communicated with the data base that the application is connected to, or alternatively, the data base and/or server would be configured to recognize a code that has been used previously thus identifying it as unsecure (likely a copy made by another person attempting a fraudulent activity). The regenerated code will contain unique security features preventing unauthorized generation of a code/unique identifier.

Remote operating system or server generates UID and corresponding security features, such as a stack of UID credentials. The UID and corresponding security is downloaded to the user's mobile device and is accessed via the application. The UID represents the token. The UID is scanned at a terminal. Via a tokenization process, the terminal communicates with the payment processing system based on the UID received (token) received. The UID is decoded and matched to the payment profile details whereby the user's payment means is processed or billed. The System then sends a signal back to the local QR code on the mobile device and/or terminal for any reason. Data embedded option that never stops changing. Dynamic QR code like video or gif. If the phone/terminal goes offline, it doesn't matter, it still knows your payment processing credentials are because its following a set code algorithmic also locally stored on the terminal. The UID is punched for the particular function and then processed later when communication is established. But it can't upload changes to the server any changes such as marking the ticket as executed etc.

Apple device reads RFID tag within receiving device, POS, or terminal, subsequently triggers payment from the phone as opposed to the legacy system wherein the payment is triggered terminal. So then we have a bilateral redundancy of triggering communication with appropriate servers. Because the system is remote then the payment can be initiated from either the device or the terminal.

In one embodiment the security system is described as a replacement code or fetch and push system. The code generated from the ticket data base (ticketing platform most commonly a 3rd party) will received within the application, the application will automatically generate a new code and push it back to the ticket data base, replacing the original ticket code. This will allow the new code to be validated by scanning for access (when fetched from ticket data base) and will also serve as the payment token. After each purchase or at predetermined intervals a new code will be generated by the application (after discarding the previous one) and pushed to replace its predecessor.

In one embodiment the security system is described as a dual-code system. Within the application there will be a section reserved for the ticket. Within that section will be separate buttons for access and payment. When one wants to gain access to the event, they push the access button. When they wish to make a payment, they press the payment button. The access code will be either supplied by the ticketing platform, or generated by the application depending which company is handling the technology for access to the event. The payment code will be generated by the application. At predetermined intervals, or after each purchase transaction, the application will discard the old payment code and create a new payment code which is done for payment security purposes.

In another embodiment, the security system is described as a Static Multi-Use Code system; the code generated from the ticket data base (ticketing platform) will also be used as the payment token. This is achieved by sending the ticket's code to the stored payment data server and attaching it to the Patron's payment profile that was used for purchasing the ticket. Once the code has been attached to the profile it can now be used for access and payment.

Each time the ticket's unique identifier is scanned for a purchase the Patron will be required to validate his identity by using a security feature such as entering a PIN number, using fingerprint verification or other acceptable (in terms of security) method in order to complete the transaction.

In another embodiment, a paper or non-electronic ticket option can also be offered.

Accordingly, additional A PIN number or other form of verification such as a fingerprint scan will be required to be selected/utilized by Patron at the time of ticket purchase, and/or within the application. Each time the ticket's unique identifier is scanned for a purchase the Patron will be required to enter his PIN number in order to complete the transaction.

Global system operation under general circumstances is schematically shown in FIG. 4.

The operation of the security system under typical circumstances is schematically shown in FIGS. 2A and 2B. The system operates on one or more computers, typically one or more file servers connected to the Internet. The system is typically comprised of a central server that is connected by a data network to a user's computer. The central server may be comprised of one or more computers connected to one or more mass storage devices. A website is a central server that is connected to the Internet. The typical website has one or more files, referred to as web-pages, that are transmitted to a user's computer so that the user's computer displays an interface in dependence on the contents of the web-page file. The web-page file can contain HTML or other data that is rendered by a program operating on the user's computer. That program, referred to as a browser, permits the user to actuate virtual buttons or controls that are displayed by the browser and to input alphanumeric data. The browser operating on the user's computer then transmits values associated with the buttons or other controls and any input alphanumeric strings to the website. The website then processes these inputs, in some cases transmitting back to the user's computer additional data that is displayed by the browser. The precise architecture of the central server does not limit the claimed invention. In addition, the data network may operate with several levels, such that the user's computer is connected through a fire wall to one server, which routes communications to another server that executes the disclosed methods. The precise details of the data network architecture does not limit the claimed invention. Further, the user's computer may be a laptop or desktop type of personal computer. It can also be a cell phone, smart phone or other handheld device. The precise form factor of the user's computer does not limit the claimed invention. In one embodiment, the user's computer is omitted, and instead a separate computing functionality provided that works with the central server. This may be housed in the central server or operatively connected to it. In this case, an operator can take a telephone call from a customer and input into the computing system the customer's data in accordance with the disclosed method. Further, the customer may receive from and transmit data to the central server by means of the Internet, whereby the customer accesses an account using an Internet webbrowser and browser displays an interactive webpage operatively connected to the central server. The central server transmits and receives data in response to data and commands transmitted from the browser in response to the customer's actuation of the browser user interface.

A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The method described herein can be executed on a computer system, generally comprised of a central processing unit (CPU) that is operatively connected to a memory device, data input and output circuitry and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the 10 circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory.

Examples of well-known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, etc.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.) It is appreciated that any of the software components of the present invention may, if desired, be implemented in ROM (read-only memory) form. The software components may, generally, be implemented in hardware, if desired, using conventional techniques.

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer.

FIG. 4 illustrates the initial enrollment of a user patron in the system. A patron wishing to establish an account contacts the computer system using a network, such as the internet, and, at using conventional browser technology, establishes an account on the system. The system, in a manner well understood in the art, obtains information from the patron, including name, address, email address, credit card information, all of which is stored in the system, and is associated with an account number record which is individual to that user. The user is required or elects whether to receive a secondary device such as an RFID pass, RFID tag, or bracelet incorporating proximal communication technology as a secondary device for use of the system in addition to their mobile device—as a way to provide additional redundancy of the system, especially in case the user's mobile device is powered down because of a low battery and is therefore inoperable at an event. The pass or bracelet can be mailed to the user or obtained at the event or venue.

FIG. 4 shows how the patron uses the system, for example, to buy a ticket to an event or to enable the User account to be used to purchase goods at events. As shown at 1, the patron goes to the User website and logs in using his User account number and/or unique log-in and password information. The system using software well known in the art, allows the patron to deposit money into the account for subsequent purchases, or enables the User account to link to and charge debits to an existing credit or debit card account of the patron. Provided there is payment capability associated with the account, the system then at 4 allows the patron to purchase admission to an event, for example, an upcoming concert, and confirms the transaction and method of payment, e.g. charged to User account or credit card account. The system may also provide the patron with information regarding the funds available in the User account and other information, e.g. advertising for other upcoming events, reminders about events for which the patron has previously purchased admission.

Once the patron has established an account in the User system and received the user mobile device ticket containing the account identifying information, the patron can buy access to live events, such as concerts, or entertainment venues, such as theme parks, by accessing the User system online. The public is already familiar with purchasing concert tickets and the like online and the technology needed to provide a web-based ticket purchase system is well understood and will not be described in detail in this patent.

Once the patron has purchased access, the details are stored in the computer system in association with the identifying data record for the patron's account and the patron is provided with confirmation of the purchase, including details of the event, such as location and time of the event, section to which admission is afforded and seat selected.

As discussed above, once the account is established, the system provides the patron with a pass used to gain entry to events and to make purchases at events using the User system. Preferably, the pass is in the form of a user mobile device having a platform displaying or accessing an electronic ticket containing readable data identifying the patron's account. The data is preferably contained within machine-readable storage within the user mobile device and/or an RFID chip device embedded in a wearable user mobile device. The data is capable of being transferred using one or more proximal communication protocols such as barcode, DEI, QRcode, NFC, frequency, inaudible or audible sound, ultrasonic frequency or sound, NFC, RFID, Bluetooth, and/or BLE.

Referring to FIG. 4, in some embodiments a fan operating as a user of the system, decides he/she wants to buy a ticket to a live event and first goes online to an online ticket broker website to search for and purchase a ticket, this representing the ticketing system shown in FIG. 1. As an alternative to selecting a delivery option, or print at home option (not shown), the fan selects the mobile ticket option to use a downloaded application platform on his/her mobile device. Additionally, in some embodiments the user can elect to receive a reusable, universal bracelet ticket for ticketless access to the event. In either scenario, the user is and is then re-routed to the login page of a user account system. The user will then will log in to his personal user account or, if the fan is a first time user, the user will register to become a member by filling out a personal profile and joining. The website, portal, and/or application platform interface offers members the ability to search, buy, sell, and trade event tickets, and use their reusable bracelet ticket for expedited ticketless access and contactless payments at a multitude of live events.

As shown in FIGS. 1 and 4, in order to use the services offered on the mobile ticketing and payment system, each user must sign up and fill out a personal account with personal information that may include contact information such as a current mailing address, a personal email address, full name of the user, preferred contact phone number, and banking information, such as credit card or bank routing information. A database stores the user account profile information and activates and/or issues a credential or pass that is associated with a user account and/or transferred and/or downloaded and/or displayed via the user mobile device. In some embodiments this in the form of an RFID-enabled wristband with unique data that is associated with a particular user account 5. The user account may include event access privileges and stored value to be used by the fan at live events to purchase concessions and merchandise. In a preferred embodiment no personal data or banking information is stored locally on the user device, bracelet, and/or on the associated proximal communication chip or appropriate processor housed within the user mobile device. Instead, the user account data is stored on a secure server, such as a secure PCL-compliant server, for security reasons.

Once the event ticket is purchased the fan, if a first time user, selects a preferred method of distribution for the electronic ticket, which can be accessed via the user's mobile smartphone and/or mailed as a secondary mobile user device, such as a bracelet, in the mail via the delivery services provided by UPS for example. Alternatively, if desired, in some embodiments the fan can pick up a secondary RFID or proximal security system enabled mobile device, such as an electronic bracelet, in person at the live event at a secure location such as Will Call or a designated entry point.

FIG. 4 shows how the patron uses the system, for example, to buy a ticket to an event or to enable the User account to be used to purchase goods at events. As shown at 1, the patron goes to the User website and logs in using his User account number and/or unique log-in and password information. The system using software well known in the art, allows the patron to deposit money into the account for subsequent purchases, or enables the User account to link to and charge debits to an existing credit or debit card account of the patron. Provided there is payment capability associated with the account, the system then at 4 allows the patron to purchase admission to an event, for example, an upcoming concert, and confirms the transaction and method of payment, e.g. charged to User account or credit card account. The system may also provide the patron with information regarding the funds available in the User account and other information, e.g. advertising for other upcoming events, reminders about events for which the patron has previously purchased admission.

A preferred embodiment of the platform allows users to create an account using cryptocurrency payment information or link a preexisting cryptocurrency account with his/her payment account to be used for purchasing tickets and making purchase at the venue. A cryptocurrency funded account allows a user to make purchases without having to be subject to the addition credit card processing fees and tracking that come with traditional credit cards. Furthermore, this allows festivals and venues to implement a system that independent from credit card processing fees, saving potentially thousands of dollars in processing costs associated with goods and services sold at the event and the ticket costs.

Once the patron has established an account in the User system and received the user mobile device ticket containing the account identifying information, the patron can buy access to live events, such as concerts, or entertainment venues, such as theme parks, by accessing the User system online. The public is already familiar with purchasing concert tickets and the like online and the technology needed to provide a web-based ticket purchase system is well understood and will not be described in detail in this patent.

Once the patron has purchased access, the details are stored in the computer system in association with the identifying data record for the patron's account and the patron is provided with confirmation of the purchase, including details of the event, such as location and time of the event, section to which admission is afforded and seat selected.

As discussed above, once the account is established, the system provides the patron with a pass used to gain entry to events and to make purchases at events using the User system. Preferably, the pass is in the form of a user mobile device having a platform displaying or accessing an electronic ticket containing readable data identifying the patron's account. The data is preferably contained within machine-readable storage within the user mobile device and/or an RFID chip device embedded in a wearable user mobile device. The data is capable of being transferred using one or more proximal communication protocols such as barcode, DEI, QRcode, NFC, frequency, inaudible or audible sound, ultrasonic frequency or sound, NFC, RFID, Bluetooth, and/or BLE.

Referring to FIG. 4, in some embodiments a fan operating as a user of the system, decides he/she wants to buy a ticket to a live event and first goes online to an online ticket broker website to search for and purchase a ticket, this representing the ticketing system shown in FIG. 1. As an alternative to selecting a delivery option, or print at home option (not shown), the fan selects the mobile ticket option to use a downloaded application platform on his/her mobile device. Additionally, in some embodiments the user can elect to receive a reusable, universal bracelet ticket for ticketless access to the event. In either scenario, the user is and is then re-routed to the login page of a user account system. The user will then will log in to his personal user account or, if the fan is a first time user, the user will register to become a member by filling out a personal profile and joining. The website, portal, and/or application platform interface offers members the ability to search, buy, sell, and trade event tickets, and use their reusable bracelet ticket for expedited ticketless access and contactless payments at a multitude of live events.

As shown in FIGS. 1 and 4, in order to use the services offered on the mobile ticketing and payment system, each user must sign up and fill out a personal account with personal information that may include contact information such as a current mailing address, a personal email address, full name of the user, preferred contact phone number, and banking information, such as credit card or bank routing information. A database stores the user account profile information and activates and/or issues a credential or pass that is associated with a user account and/or transferred and/or downloaded and/or displayed via the user mobile device. In some embodiments this in the form of an RFID-enabled wristband with unique data that is associated with a particular user account 5. The user account may include event access privileges and stored value to be used by the fan at live events to purchase concessions and merchandise. In a preferred embodiment no personal data or banking information is stored locally on the user device, bracelet, and/or on the associated proximal communication chip or appropriate processor housed within the user mobile device. Instead, the user account data is stored on a secure server, such as a secure PCL-compliant server, for security reasons.

Once the event ticket is purchased the fan, if a first time user, selects a preferred method of distribution for the electronic ticket, which can be accessed via the user's mobile smartphone and/or mailed as a secondary mobile user device, such as a bracelet, in the mail via the delivery services provided by UPS for example. Alternatively, if desired, in some embodiments the fan can pick up a secondary RFID or proximal security system enabled mobile device, such as an electronic bracelet, in person at the live event at a secure location such as Will Call or a designated entry point.

FIGS. 1 to 4 show the operation of the system when a user attends an event. When the patron reaches the perimeter of the event, he produces the user mobile device having the platform application installed, which is capable of displaying and/or communicating user information and ticket information. The user mobile device is read by a client device operating as a reader or terminal at a perimeter of the event using the proximal communication system of FIG. 3 and in some embodiments also the global communication system is used. Accordingly, the client device transmits a signal representative of the account identity to the user account system and/or ticketing system, FIG. 1. Operating the security system shown in FIGS. 2A and 2B, the security system interrogates the data stored in the appropriate system and, sends a reply signal to the event reader indicating whether access should be granted or denied.

FIGS. 1 to 4 also show the use of the user mobile device operating as a ticket at the event after access has been gained, whereby it operates as a mobile payment device. The user mobile device can be used to purchase food, drink, souvenirs or other goods at a concession stand at the event by interacting with the client mobile device over the proximal communication system of FIG. 3, while again using the security system of FIGS. 2A and 2B. In some embodiments, the user presents a user mobile device or electronic bracelet ticket at a concession stand. A user device operating as a POS, terminal, and/or reader at the concession stand receives necessary information from the user mobile device or bracelet or reads user device. The system then interrogates the user account system to ensure that sufficient credit or funds are available in the user's account to cover the purchase requested. If there is, the system signals the event staff managing the concession stand that the transaction can proceed. An appropriate debit transaction is made to the user's account and details of the transaction, what was purchased, where and when the purchase was made, and the cost of the purchase, are recorded in the account.

It will be understood that, in practice, the funds transfer functions of the system may not happen in real-time and that funds may move between accounts at some time after the sale transaction is performed. Moreover, transfer of funds to the venue or to vendors will generally be batched and not handled as individual occurrences.

Once at the event or venue a user or fan presents the user mobile device to be scanned by event security by a client mobile device such as a smartphone having reader capabilities. In some embodiments the client device can also be simply be a traditional NFC or RFID reader, such as the readers marketed by NCR and others, which wirelessly reads the NFC and/or RFID chip inside the user's mobile device or RFID and/or NFC-enabled wristband. Then the overall system operates the security system shown in FIGS. 2A and 2B and transmits identifying data to the account and/or ticket server's database, which verifies whether or not the ticket was in fact purchased for the event. The security system then authenticates the ticketless access request and transmits an ‘access granted’ message back to the client device and also updates the event ticketing system so that the same pass cannot be used again for reentry by another person for the same event in some embodiments. In some embodiments the access granted or transaction approval message can be in the form of a textual and/or graphical image displayed by the client device and/or user device.

In one embodiment, an approval can include or generate a 3-D image or hologram displayed by a designated client device to communicate that a user is authorized to perform the function requested.

If the credential or pass or ticket is validated by the appropriate server, the event security or automated system hardware (e.g. an automated or electronic gate or turnstile) allows the fan or user to access the event, just as if the fan had presented a traditional paper event ticket. When this occurs, in some embodiments the security system updates the appropriate server database to reflect that access has been granted. Accordingly, in some embodiments if a second request for access to the event is received from the same pass, the request will be denied and the event notified.

Once inside the event the user can use his/her mobile device as a contactless payment device to purchase concessions and merchandise. At the point of purchase or POS (e.g, a concession stand, a gift shop), the user produces or waves his/her user mobile device within read range of a contactless point of sale RFID reader, usually in the form of a client mobile device, more specifically a client smartphone having proximal communication hardware and software capabilities in order to make a payment, which is most embodiments does not require physical contact between the devices and is wireless. In other embodiments the client device is a reader such as the contactless POS terminals marketed by First Data or ViVOtech. The client smartphone or client RFID reader reads the proximal communication protocol or protocols produced by the user device using the proximal communication system of FIG. 3. The client device then operates the security system of FIGS. 2A and 2B and transmits a signal to the venue's point of sale (POS) system or directly to the user account system, which is linked to an appropriate server containing user account date. As shown in FIGS. 2A and 2B, the appropriate server verifies that the user has funds available on his account to make said purchase and if funds are available the security system approves the transaction and communicates the approval back to the POS. The user account system transfers the funds from the user's account user's payment means to the appropriate bank account or other financial means specified by the client (event or venue operator) and the transaction is completed. Those skilled in the art will be aware that in such systems, the actual transfer of funds is typically a batched operation and that individual transfers of funds are not made with each transaction

The operation of the integrated security system is schematically shown in FIGS. 2A and 2B. The platform is invoked when a user desires access to an event at least partially managed by the platform. Accordingly, the user either initializes the platform via an interface. A primary use of the platform is via the installation of a mobile application on a mobile device and interfacing with said platform via the mobile application. Alternatively, the interface can comprise a web portal on a mobile device via a web browser or use of a web browser on a traditional electronic device, such as a computer.

Alternatively, the customer information, including the user's profile and payment information, can be received from a third party application or system to initialize the user profile maintained by the platform.

In a preferred embodiment, a two-factor authentication system is required. The second factor of authentication corresponds to the user confirming his/her identity by providing an additional input. The second factor of authentication inputted by the user can include a PIN number or a password previously set by the user or provided to the user by the security system or another unique form of verification known only to the particular user and capable of being verified by the security system. In some embodiments, the second factor of authentication can be a biometric identifier of the user, including a fingerprint scan, a facial recognition or image, DNA, or another unique form of biometric verification.

In one embodiment, existing password, and/or PIN information, and/or biometric identifying information stored or accessed locally by the user's device is transmitted to the user account system and stored on a remote server. The security system of the present invention can therefore call upon such information for authentication and verification of the user when the user attempts certain actions using his/her mobile device, such as access or payment.

In some embodiments the aforementioned two-factor identification security system design allows a user to continue operating the access privileges and payment means associated with his/her user account, even if the user's primary user device becomes unavailable because it was lost or stolen or will no longer operate turn on because of power loss or a dead batter. Under this scenario, the user could simply provide a password, or a PIN, or biometric identifying information associated with his/her user device along with a traditional hard copy of a ticket and/or identification (e.g. driver's license, ID card, credit card) or some other information associated with the user's account such as the user's phone number, social security number, or appropriate answers to security questions.

Operation of the proximal communication system is schematically shown in FIG. 3. In most embodiments, the proximal communication system will be activated by following the steps depicted in FIG. 4 of typical system use. The integrated security system of FIGS. 2A and 2B will usually be invoked and operated when the general system operation shown in FIG. 4 in conjunction with the proximal communication system depicted in FIG. 3.

Generally the electronic ticketing and mobile payment system comprises a proximal communication system facilitating the transfer of data between a user device and a client device so that a user can effectively present and use the user's electronic ticket and provide a mobile payment means for goods or services at the event. In a preferred embodiment, the client device includes multiple proximal transmission protocol capabilities incorporating the all of or some of the following transmission means technology or protocols: a Near Field Communication (NFC) means; a Bluetooth means; a Bluetooth Low Energy (BLE) means; an audible or inaudible sound or frequency; an ultrasonic signal transmission; a Radio Frequency Identification (RFID) means; a WiFi means; a Graphical User Interface (GUI); a Graphical Client Interface (GCI); a data embedded image (DEI); a barcode; a Quick Response (QR) code; and, any other wireless form of communication.

In a preferred embodiment the proximal communication system incorporates a user device comprising: a user communication interface (UCI); and, a user capability; a client device comprising: a client communication interface (CCI); and, a client capability. at least one sensor capable of: sensing a nearby UCI or CCI; identifying at least one signal; measuring at least one performance indicator of said signal; recording said at least one performance indicator analyzing said at least one performance indicator in accordance with available data to make a determination. a layered protocol capable of: communicating with said at least one sensor; identifying one or more available protocols according to said at least one signal identified by said at least one sensor; optimizing at least one transceiver means using said determination provided by said at least one sensor; establishing at least one connection between said UCI and said CCI using said at least one transceiver means; permitting unidirectional and bidirectional wireless transfer of said encrypted data across said at least one connection; transferring said encrypted data between said user device and said client device; and, using at least two protocols of said one or more available protocols simultaneously.

In some embodiments, the performance and operation of said proximal communication system is dependent upon on usage specifications comprising: environmental factors; said client capability; and, said user capability. In a preferred embodiment, said client capability equals or exceeds said user capability and said available data comprises said usage specifications. Accordingly said layered protocol operates when said a maximum capability of said user capability of said user device meets or exceeds a minimum capability of said client capability of said client device. The UCI connects to said CCI via said layered protocol when said user and/or said client reduces a relative distance between said user device and said client device below a maximum threshold defined by said user capability and/or said client capability.

In one embodiment the said available data further comprises two or more performance indicators of said signal. In another embodiment, said available data further comprises at least one additional performance indicator of at least one additional signal. In a preferred embodiment, said UCI connects to said CCI via said layered protocol when said user device is near or proximal to said client device or when said user device is within a wireless range of said client device as prescribed by said user capability and/or said client capability.

Radio frequency identification, or RFID, is a generic term for technologies that use radio waves to automatically identify people or objects. There are several methods of identification, but the most common is to store a serial number that identifies a person or object, and perhaps other information, on a microchip that is attached to an antenna (the chip and the antenna together are called an RFID transponder or an RFID tag). The antenna enables the chip to transmit the identification information to a reader. The reader converts the radio waves reflected back from the RFID tag into digital information that can then be passed on to computers that can make use of it.

The RFID transponder chip device is housed within a user mobile device such as a smartphone or electronic bracelet ticket. The device 32 is arranged to function as a stored value card, or as a gift card, or as a debit or credit card linked to an established account at a financial institution, or a member's pass account. It can also allow the user device to function as a ticket for entry to a concert or other event, or to a particular seat or area, such as at a VIP enclosure, within the event.

In some embodiments the system includes a primary user device, typically the user's smartphone and a secondary user device, typically an electronic wristband or bracelet or a smartwatch that is capable of proximal communication. In the form of a wristband or bracelet used as a secondary access and payment device, a barcode can be applied to the exterior of the bracelet to be used for communications purposes, as the access control and payment applications previously described.

In a preferred embodiment a bracelet or wristband itself contains a barcode and/or a RFID-enabled device or other proximal communication mechanism or chip that enables data to be stored and retrieved, transforming the bracelet into a communications device and allowing it to function as a wearable event ticket and as a payment device, obviating the need for a paper ticket or separate money card or substituting for the absence of the user's primary device or smartphone as the electronic ticket and payment means.

Preferably, the information is stored on the bracelet by means of a contactless device receiving and transmitting data by, for example, radio frequency, such as the passive RFID chip devices developed by Texas Instruments. A conventional barcode or an antenna could be printed on the exterior of the bracelet using, for example, conductive inkjet technology developed by Carclo. In operation, the patron uses the bracelet in the same manner in which conventional RFID bracelets are used. The bracelet is attached to the wrist or other body part of the patron and then, when unique identification is necessary, the user must bring the bracelet within a certain distance of an RFID reader (the “read range”), which transmits a wireless signal. When within that distance, the RFID chip will be powered by the wireless signal from the RFID reader and, in response, transmit to the RFID reader its own wireless signal representative of the unique information pre-stored or pre-programmed in the chip. The reader may be linked to a microprocessor having a database of relevant information pertaining to the unique bracelet identification or that communicates with the pass network database.

Upon exiting an access area, the ticket information linked to the user profile is updated to reflect use of the ticket and exit of the user. Accordingly, the ticket information linked to the user profile is updated to reflect use of the ticket and exit of the user. If the user exits and then desired reentry to the designated access area at an access point, the platform accepts or denies the request based on instructions received form the management system.

Upon a user exiting an event or venue, the system could allow or incorporate a reentry option for users in attendance. In this instance, a user could elect to obtain a reentry option by visiting a designated client device. The user would establish proximal communication with the designated client device using his/her user device to request a reentry allowance. In some embodiments, the allowance for reentry may be a conditional permission dependent on time and location. For instance, the user may only be able to reenter before or after a certain time or is allotted a limited duration to exit the event or venue.

If the customer purchases goods or services inside the venue by approaching a traditional POS point or terminal and engages the corresponding POS system using at least one specified transmission means previously described. This action may be performed before or after the good or service is delivered to the user and may occur with or without user action (e.g. an automated system).

In addition to the purchase of a good or service, the user can initiate and obtain a benefit such as additional access, coupons, promotional materials, etc. The customer can also utilize a customized menu pushed to his/her mobile device application to initiate and complete a purchase or benefit. This capability allows the customer to remain at his or her present seat or location and have the good or service delivered. Under this scenario, the event management system pushes a customized menu to the user's mobile device using the platform.

If the customer purchases goods or services inside the venue by approaching a traditional POS point or terminal and engages the corresponding POS system using at least one specified transmission means previously described. This action may be performed before or after the good or service is delivered to the user and may occur with or without user action (e.g. an automated system).

The User could also automatically set his/her device and/or account to enable the purchase of restricted food or beverages, such as alcohol, the sale of which is restricted to persons of legal drinking age. Under this scenario, the user at the time of account signup or ticket purchase using a web interface, or subsequent thereto using the application or platform via the user's mobile device can ask the system to authenticate the user as a user of legal drinking age allowed to purchase alcohol or beer at events or venues. This could be accomplished by the user inputting necessary information or data from the user's driver license or Identification (ID) card or passport or similar official document, collectively referred hereafter as ID, meaning any of these types.

In a preferred embodiment, the system allows the user to present his/her ID to a sensor or interface component such as a camera. This would usually work with the camera on the user's device. Essentially the user could operate the application installed on the user's device and would navigate to an age verification portion produced by the application and displayed via the GUI. The user would then authorize the application to allow use of the user's camera on the user's mobile device, if the user has not already done so, and the user would take a picture or snapshot of the front and/or back of his/her ID. The system would analyze the picture of the ID and extract textual and/or graphical information including any barcodes or other codes provided on either side of the ID. The system would then communicate at least some of the extracted ID information, typically a barcode and/or date of birth (DOB) with a known verification or authentication database, often provided by an official authority or government entity, to verify and authenticate the user as a user of legal drinking age. Alternatively, this verification and authentication could also be performed using a client device and/or official designated by the client at the event or venue at a designated area (e.g. ID tent or desk), at a terminal, at a kiosk, and/or at a POS (e.g. a cash register at a concessions stand that sells beer). This on-site verification could be automatically performed using the camera on the client's device and/or could be performed by a manual check or verification of the user's ID and a subsequent permission entered or into the system or update thereof.

In a preferred embodiment, a user can be required to input or scan, according to the methods discussed, his/her user ID as a mandatory requirement set by the client. This would therefore then provide an additional security measure authenticating the user and/or the user's device upon operating the user mobile device to gain access or make a payment at the client's event or venue.

In a preferred embodiment, when a user scans or otherwise inputs data or coding corresponding to his/her ID information, the user account system can accordingly update the user's user profile to include this additional information such and age and geographical location. In such embodiments, the system would be available to generate more powerful analysis of user demographics that would be advantageous for marketing. Under any of these circumstances, after the user has been verified or authenticated as a user of legal drinking age, the user's mobile device would thereafter also serve as a status identifier indicating legal drinking age. This would take the place of a wristband or stamp traditionally provided by events or venues designating the user to be legal drinking age.

Similarly, these capabilities could also be used to appropriately designate a user as a minor or one that is of non-legal drinking age.

In a similar manor to the designation of legal drinking age, the customized menu feature provided on a user's device would also include offering status upgrades or additional privileges associated with a ticket of the user, including access privileges or status privileges such as a Very Important Person (VIP) status designation as desired.

### Service Ecosystem

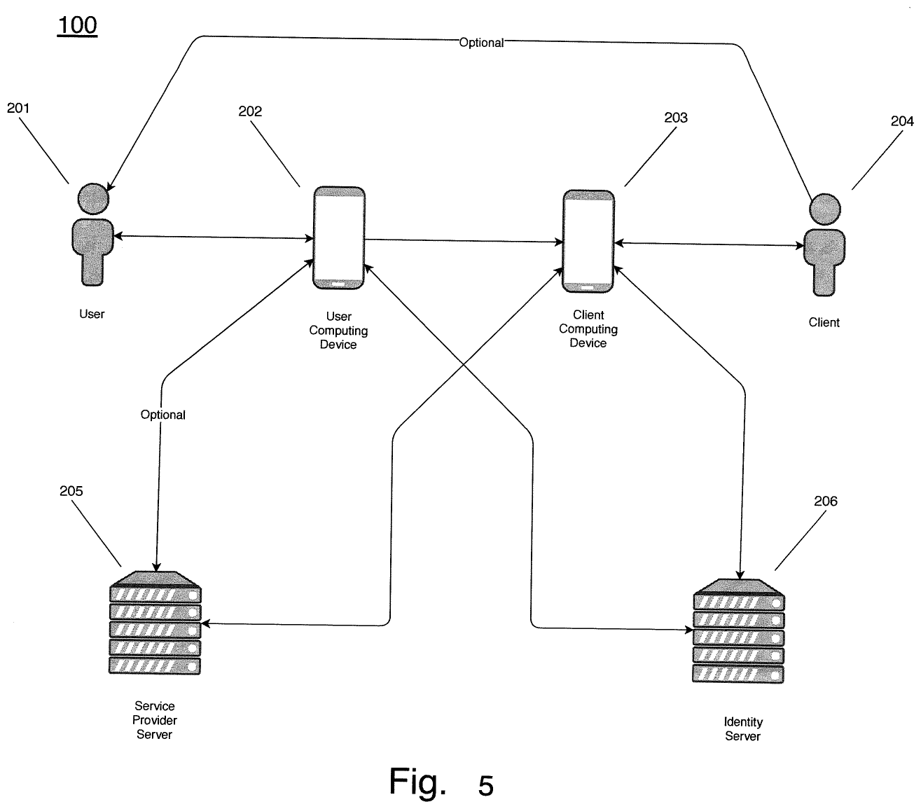

A second preferred embodiment is shown schematically in FIGS. 5 to 18, which outlines the organization and operation of the overall system. In this secondary embodiment, a compartmentalized design approach is used regarding the system architecture. This design organizes functions into separate discreet applications, services, and features.

FIG. 5 illustrates a system 100 for the identification of a user 201 by a client 204, where that identity is passed to a service provider to provide a service using the method of the present invention.

The method for completing a transaction between a user 201 and a client 204 who is a supplier of goods and/or services comprises providing a personal communication device (PCD) 202 which is associated with the user 201 and providing a receiving communication device 203. On a remote identity server 206 storing information from the PCD 202 relating to the user 201.

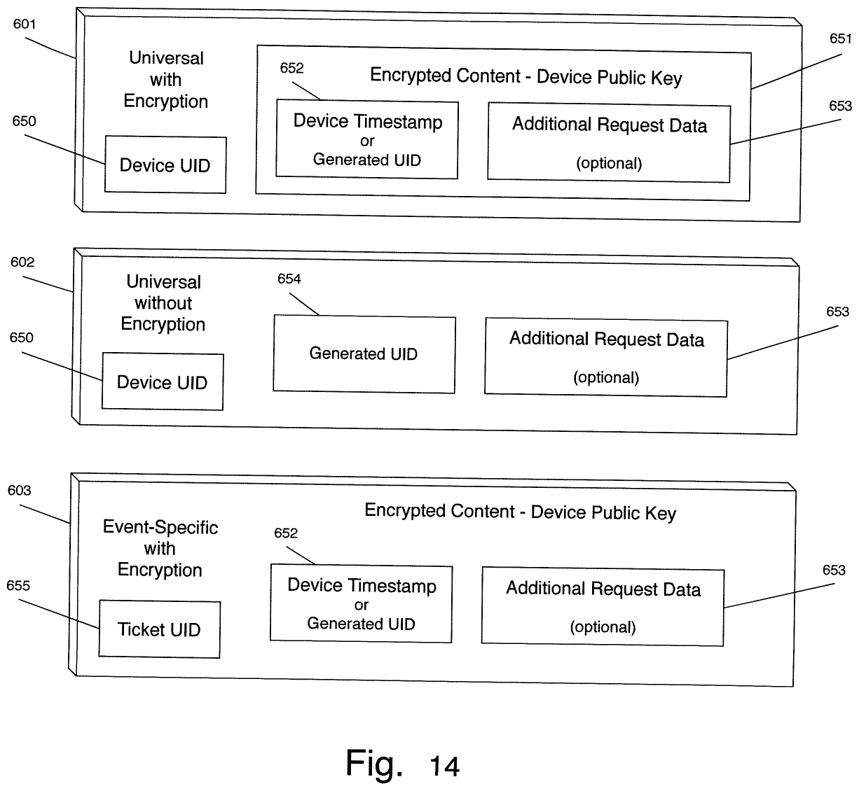

In a preliminary information exchange between the PCD 202 and the remote identity server, the method includes establishing the framework for a data set 601 in FIG. 14 sharing a special relationship between the remote computing device and the receiving device.

In the event that the user 201 wishes to obtain goods and/or services from the supplier, the method causes the PCD to build and transmit to the receiving device 203 the data set and causes the receiving device 203 to forward the received data set to the remote identity server 206 for processing and identification of the user 201, the remote identity server 206 acting to provide data to the receiving device 203 identifying the user 201.

As shown in FIG. 14 and described in more detail hereinafter, the data set is established such as to only be recognizable as valid by said remote identity server 206, and to not be easily reproduced by an unauthorized third party.

The system 100 may include a computing device 202, which is owned/controlled/used by a user 201, who wishes to be provided a service. The device 202 may be any computing device capable of transmitting a SID, and communicating with the identity server 206. The data set or SID, discussed in more detail below, is generated on the device 202 using data components received from communications with the identity server 206. The identity server 206, also discussed in more detail below, may be any type of computing device suitable for performing the functions discussed herein.

The computing device 202 may transmit the SID via any suitable wired or wireless means, such as but not limited to: NFC, Bluetooth, WiFi, audio (audible or ultrasonic), infrared, RFID, cellular data, and visible patterns such as barcodes.

The computing device 202 and identity server 206 may communicate using any suitable communication network, method, and/or combination, such as but not limited to: wired local area network, cellular data, WiFi, and the Internet.

A service provider who controls the service provider server 205, creates a software application for the device 202 which user 201 will use to control device 202. The software application for device 202 will provide the functionality for the device 202 to transmit its SID to device 203, to communicate with identity server 206, and if desired, communication with service provider server 205. Server 205 may be any type of computing device suitable for the service offered by its controlling service provider. Server 205 may communicate with device 202 in any of the same manners than device 202 may communicate with server 205, as stated above.

The service provider above who controls service provider server 205 must be registered with the software controlling identity server 206. From this registration, the service provider of server 205 will receive a UID to include in all communications from all software applications and services, on all devices, that are using the service provided by server 205. Included in the registration of the service provider of server 205 with the software on identity server 206 are: one or more categories for types of services offered, type of communication method for each category of service, and if required, API endpoints for each category of service.

The software application for device 202 may incorporate an SDK for its credential gathering, SID generation and transmitting, and for its communications with the identity server 206. If an SDK is not incorporated or employed, then an API for the software on identity server 206 may be used to define the communications between device 202 and identity server 206; custom software features in the software application on device 202 would then be used for other features/requirements defined herein. In order to receive a SID from device 202 and identify user 201, a service provider who controls the service provider server 205 creates a software application for the device 203, which client 204 will use to control device 203. Client 204 may also offer additional services to client 201 based on the result of the digital service. The software application for device 203 will provide the functionality for the device 203 to receive the SID from device 202, to communicate with identity server 206, and if desired, communication with service provider server 205.

The computing device 203 may receive the SID via any suitable wired or wireless means compatible with the transmitting means of device 202, as defined above.

Device 202 may transmit its SID via more than one means simultaneously should it be equipped to do so; device 203 may be equipped to receive one or more of these means, and if more than one, may select (at its discretion) a means for primary use.

The computing device 203 and identity server 206 may communicate in any of the same ways device 202 and identity server 206 may communicate, as defined above.

The software application for device 203 may incorporate an SDK for its SID reception, and communications with the identity server 206. If an SDK is not incorporated or employed, then an API for the software on identity server 206 may be used to define the communications between device 203 and identity server 206; customer software features in the software application on device 203 would then be used for other features/requirements defined herein.

To receive a service, the user 201 can use their device 202 to create or login to required accounts with the identity server 206, and server 205. Once login is complete the user 201 may instruct the 202 device to transmit its SID. The 203 device operated by client 204 receives the SID, transmits it to the identity server 206, receives back from the identity server 206 a corresponding UID for the account of user 201, and forwards that UID to server 205 for service processing. Server 205 then responds to client device 203, which displays the result to client 204. If client 204 is providing additional service(s) to user 201 based on the recent service result, they are now informed on the parameters for doing so.

At any point, user 201 and their device 202, may switch roles with client 204 and device 203, such that user 201 becomes a client offering a service with device 202, and client 204 becomes a user using a service with device 203. This switch of course relies upon each device

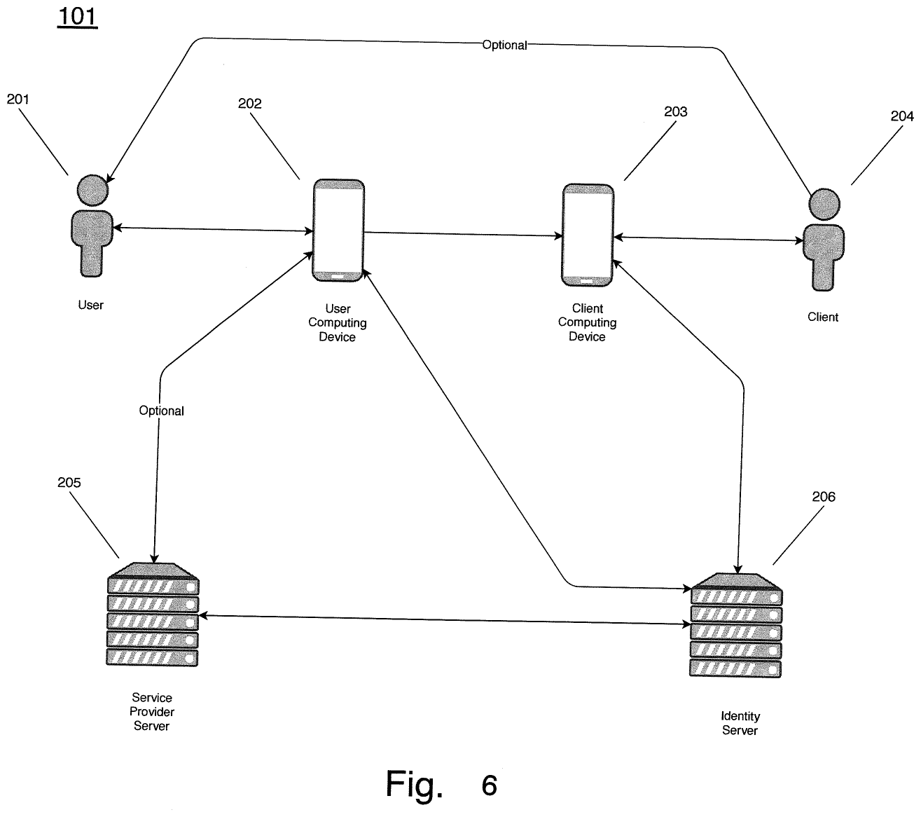

FIG. 6 illustrates a system 101 for the identification of a user by a client, where that identity is passed through the identity server, to a service provider, to provide a service.

The system 101 incorporates from a high level all the same components as system 100, with the difference being that service requests are passed from client device 203 to identity server 206 along with the SID and service provider UID, before being passed to the service provider server 205 for service processing. Server 205 then responds to the identity server 206 with the result of the service; identity server 206 then forwards the result from server 205 to client device 203, which displays the result to client 204. If client 204 is providing additional service(s) to user 201 based on the recent service result, they are now informed on the parameters for doing so.

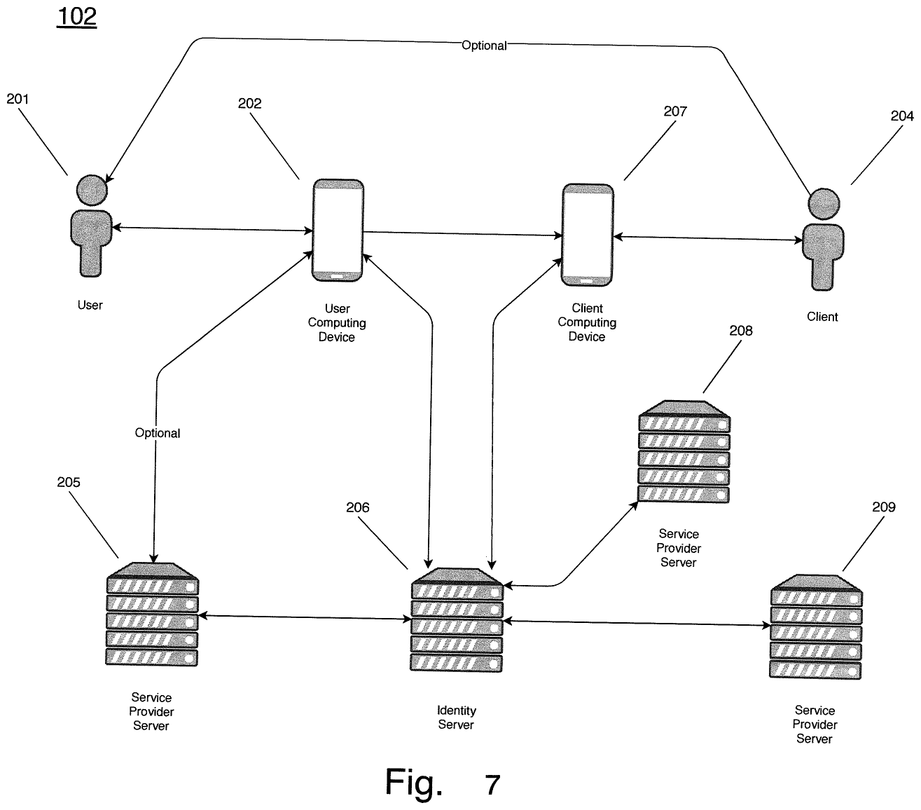

FIG. 7 illustrates a system 102 for the identification of a user by a client, where that identity is passed through the identity server, to a service provider, to provide a service.

The system 102 incorporates from a high level most of the same components as system 101 and system 100, with the differences being: client device 203 is replaced with client device 207, and service provider servers 208 and 209 have been added. Client device 207 can be any device similar to 203, with the difference between the two being that the software application on device 207 is created by the service provider in control of service provider server 208 (instead of server 205). Service provider servers 208 and 209 are similar to that of server 205, except that they are controlled by different service providers than server 205, and each other, and may offer services of different types/categories.

To clarify, for system 102, user device 202 and server 205 both contain software applications and/or services created by the same service provider. Client device 207 and server 208 both contain software applications and/or services created by the same service provider, but different from that of device 202 and server 205. Service provider server 209 contains software applications and/or services created by another service provider different again from: device 202, server 205, device 207, and server 208.

System 102 need not be limited to the three service providers illustrated in this figure, but can be any number and combination of service providers; it is shown in this way for simplicity, and clarity. Additionally, the methods described in systems 100, 101, and 102 can all be used concurrently, in parallel, or combination.

To receive a service, the user 201 can use their device 202 to create or login to required accounts with the identity server 206, and server 205. Once login is complete the user 201 may instruct the 202 device to transmit its SID. The 207 device operated by client 204 receives the SID, and transmits it to the identity server 206. Identity server 206 detects that user 201 does not have an appropriate account with service provider 208, and so searches for an appropriate service provider that user 201 does have an account with. Identity server 206 finds such an account for user 201 with the service provider for server 209, and sends that account's UID to server 209 for service processing. Server 209 then responds to the identity server 206 with the result of the service; identity server 206 then forwards the result from server 209 to client device 207, which displays the result to client 204. If client 204 is providing additional service(s) to user 201 based on the recent service result, they are now informed on the parameters for doing so.

For example let's say user 201 wishes to purchase something from a store, at which client 204 is a teller. User 201 has an application on their device 202 which is made by service provider 205, and in this example is designed to be a city transit bus pass. While user 201 is using a bus pass application, they do have a payment account with payment service provider 209. Client 204's device 207 has an application on it which is made by a payment service provider 208, and is designed to be a point of sale application for stores like the one in this example. User 201 shows or tells client 204 what item(s) they wish to purchase, and client 204 enters or scans the item(s) into their application on device 207, and informs user 201 of the total cost. User 201 accepts the cost and instructs the bus pass application on their device 202 to begin transmitting its SID. Client 204 uses device 207 and its application to read the SID from device 202, which it then packages appropriately with the cost of the order, and any other required details, and forwards to identity server 206. The identity server receives the purchase request, and notices that user 201 does not have an account with the store's payment service provider 208. The identity server 206 finds that user 201 has a payment account with payment service provider 209, so it forwards the payment request, along with the account of user 201, and the store's deposit bank information, to payment service provider 209. Payment service provider 209 then debits the user 201's account that it has, makes or schedules a deposit to the bank account of the store for the purchase total, and responds to identity server 206. Identity server 206 then responds to client device 207, which informs client 204. Client 204 then tells user 201 the result, and releases the item(s) purchased. Note that in the case payment service provider is not equipped to make a deposit to the store's bank account, a virtual currency 700 described below, may be used as an intermediary, to ensure all parties are debited and credited appropriately for the purchase.

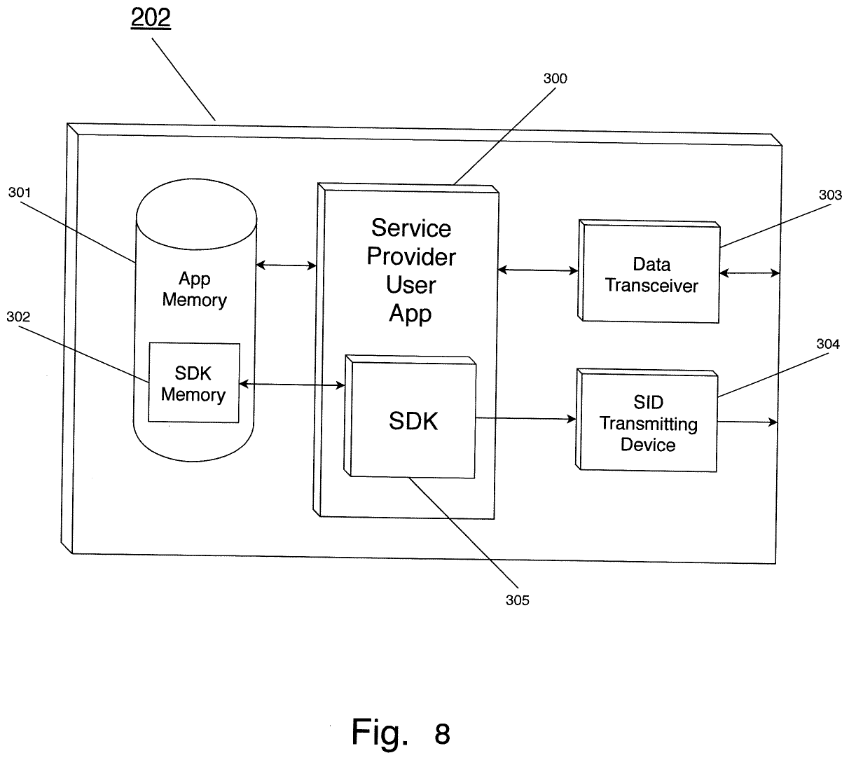

FIG. 8 illustrates in a high-level manner the architecture of the user device 202, as it appears throughout. FIG. 8 is an illustration of one possible architecture only, and is not meant to exhaust all possible configuration options.

The user device 202 may include a service provider user app 300, which provides an interface through which the user 201 can control device 202. The user app 300 may include any number of interfaces which provide access to it for memory storage, data communications, user interaction, etc.

The service provider user app 300 may include an SDK 305 which can be tasked with some or all SID related duties such as: user authentication, sensitive data storage, SID generation, SID transmission, etc.

The user device 202 may include a data transceiver 303 capable of communication using any suitable communication network, method, and/or combination, such as but not limited to: wired local area network, cellular data, WiFi, and the Internet.

The user device 202 may include a separate SID transmitting device 304 that operates using communication means not possible with data transceiver 303. These communication means include but are not limited to: NFC, Bluetooth, WiFi, audio (audible or ultrasonic), infrared, RFID, cellular data, and visible patterns such as barcodes.

The user device 202 may include app memory storage 301 for use by the user app 300. Within the app memory 301 there may be an SDK Memory 302, which is reserved for exclusive use by the SDK 305. The SDK memory 302 permits the SDK 305 the ability to store sensitive data related to device 202's SID should it be necessary, beneficial, or required.

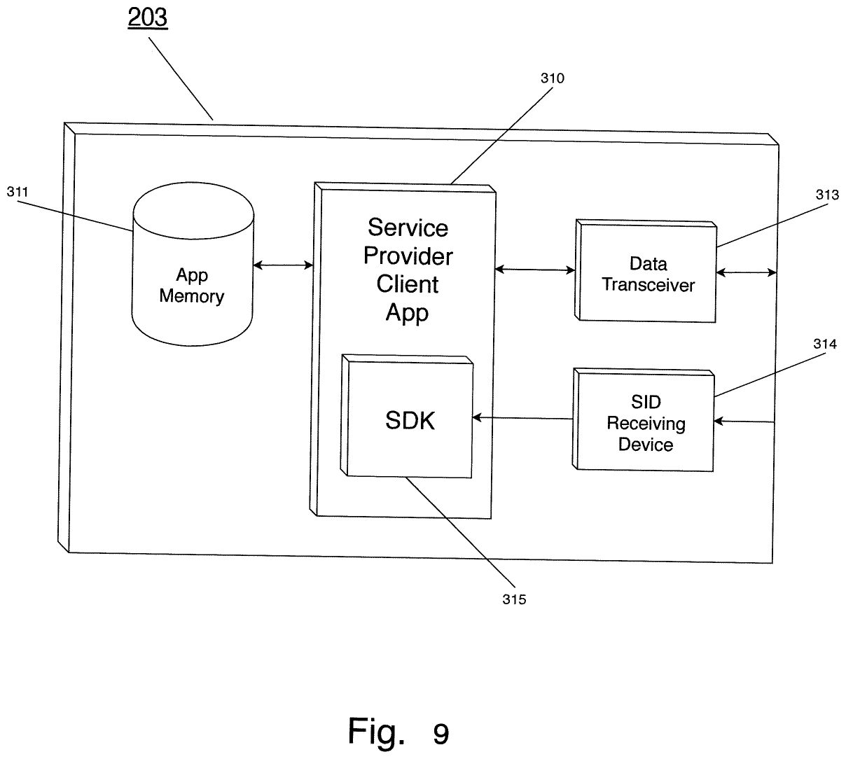

FIG. 9 illustrates in a high-level manner the architecture of the client device 203, as it appears throughout. FIG. 9 is an illustration of one possible architecture only, and is not meant to exhaust all possible configuration options.

The user device 203 may include a service provider client app 310, which provides an interface through which the user 204 can control device 203. The client app 310 may include any number of interfaces which provide access to it for memory storage, data communications, user interaction, etc.

The client device 203 may include a data transceiver 313 capable of communication using any suitable communication network, method, and/or combination, such as but not limited to: wired local area network, cellular data, WiFi, and the Internet.

The client device 203 may include a separate SID receiving device 314 that operates using communication means not possible with data transceiver 313. These communication means include but are not limited to: NFC, Bluetooth, WiFi, audio (audible or ultrasonic), infrared, RFID, cellular data, and reading visible patterns such as barcodes.

The user device 202 may include app memory storage 301 for use by the user app 300.

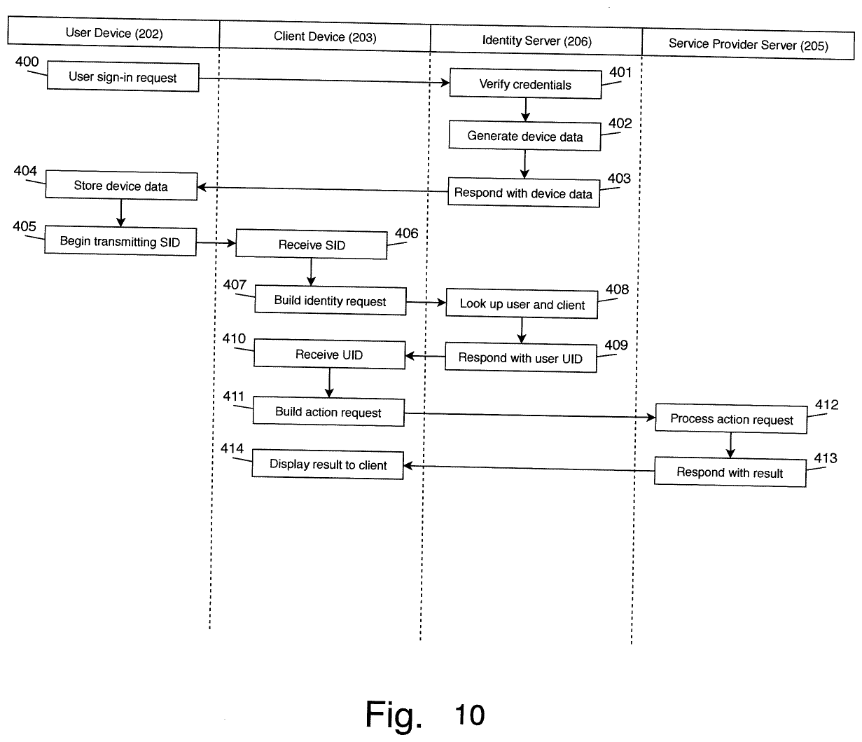

FIG. 10 illustrates the process of providing a service using the components of the identity network as defined in system 100.

In step 400, the software application for device 202 must at least initially, prompt user 201 for login credentials matching those stored on identity server 206. If the user 201 does not have credentials on identity server 206, the software application on device 202 may facilitate that in a few ways, including but not limited to: on its own through an API with identity server 206, or with features in SDK 305. The software application for device 202, after receiving the credentials from user 202, then packages the credentials with its current device 202 system time, some additional details (detailed below) about device 202. This package of data is then sent to identity server 206.

In step 401, the identity server 206 checks for validity of the credentials. If the credentials are valid, all other data in the package is stored.

In step 402, the identity server 206 calculates the difference between the device 202 system time, and its own time. This difference is recorded to determine the validity of future SIDs, as the time difference must match within a pre-determined range. The identity server 206 then generates a UID and public encryption key specific to device 202.

In step 403, the identity server 206 responds to the software application on device 202 with the UID and public encryption, and UID for the user 201 that corresponds to the service provider in control of 205.

In step 404, device 202 records the data from identity server 206, and may communicate the UID for user 201 with server 205; no further communication is required between device 202 and identity server 206 for any SIDs generated by device 202 to be valid, unless the system time on device 202 is changed. Device 202 may function completely offline; however, periodic device 202 system time updates may be sent from device 202 to identity server 206, to ensure the accuracy of that time value.

As an alternative to a device-specific public encryption key being sent from identity server 206 to device 202, a device-specific algorithm could be used instead. The algorithm would be designed to produce a UID for each SID required would be based at least in some way to the current system time of device 202. Identity server 206 would have the algorithm and the approximate time of device 202, and would be able to match and validate the SID. This approach reduces the amount of data required for a valid SID but has the disadvantage of not being able to encrypt additional data for the SID, should a payload be required.

Examples of some additional details provided by the software application for device 202 when packaging credentials include but are not limited to: user 201 defined device name, operating system name, operating system version, device 202 model number, current device 202 time zone, and any service parameters or details required by the software on identity server 206, or custom data required by the service provider software on server 205.

In step 405, user 201 instructs device 202 to begin transmitting its SID. The SID is refreshed at regular intervals by device 202, as they are no longer valid to the software on identity server 206 after a pre-determined period.

In step 406, client 204 instructs device 203 to begin listening for the SID transmission from device 202. User 201 moves device 202 into range of the SID receiving means employed on device 203, and device 203 receives the SID of device 202. Once the SID of device 202 is received by device 203, device 202 is no longer needed.

In step 407, the software application on device 203 packages the SID with its service provider UID, and sends the package to identity server 206.

In step 408, if the SID is not valid for any reason, or the user 201 does not have an account in the identity server 206 associated with the registered service provider whose UID was just passed, the identity server 206 responds to device 203 with an error response. Note that in the system 100, it is unlikely that user 201 would not have an account on identity server 206; it is mentioned for completeness.

In step 409, if the user 201 does have an account in identity server 206 which is associated with the service provider of the service provider UID just passed, then the identity server 206 responds to device 203 with the UID of the user 201's account that is associated with the service provider of the service provider UID just passed.

In step 410, device 203 receives the user 201's account UID.

In step 411, device 203 uses the user 201's account UID to build a service processing action request, and sends it to server 205.

In step 412, the server 205 takes whatever action is required to process the service.

In step 413, the server 205 responds to the service processing action request of device 203.

In step 414, device 203 informs client 204 of the result. If client 204 is providing additional service(s) to user 201 based on the recent service result, they are now informed on the parameters for doing so.

In some cases, the PCD 202 does not have a data connection to remote identity server 206, and instead relies upon a local server, or local data on the device in order to complete the identification, where the local server or data contains the required special relationship data that would otherwise be stored on and if required and/or desired, decrypted by the remote identity server.

As described above, the PCD 202 is required only to transmit the data set or SID to the receiving device 203 so that no two-way communication is required of the PCD after the data set was initially granted and provided by the remote identity server 206.

As described above, the receiving device 203 receives back from the remote identity server a unique identification of the user and the remote device uses that identification to provide said goods and/or service.

As described above, the unique identification received and shown in FIG. 14 is unique to the PCD.

As described above, the unique identification is forwarded by the receiving device to one or more additional computing devices 204 to perform or assist to provide said goods and/or service.

As described above, the receiving device 203 also sends service data/parameters as an action request along with the data set to the remote identity server.

As described above, the receiving device forwards a service request to one or more service providers, as defined by the service data/parameters to perform or assist to provide goods and/or service.

The data set is transmitted by the PCD 202 at step 405 via two or more communication methods simultaneously and the receiving device chooses which of the methods it will use.

As described above, the user is authenticated by the remote identity server on a plurality of different devices and/or software applications simultaneously.

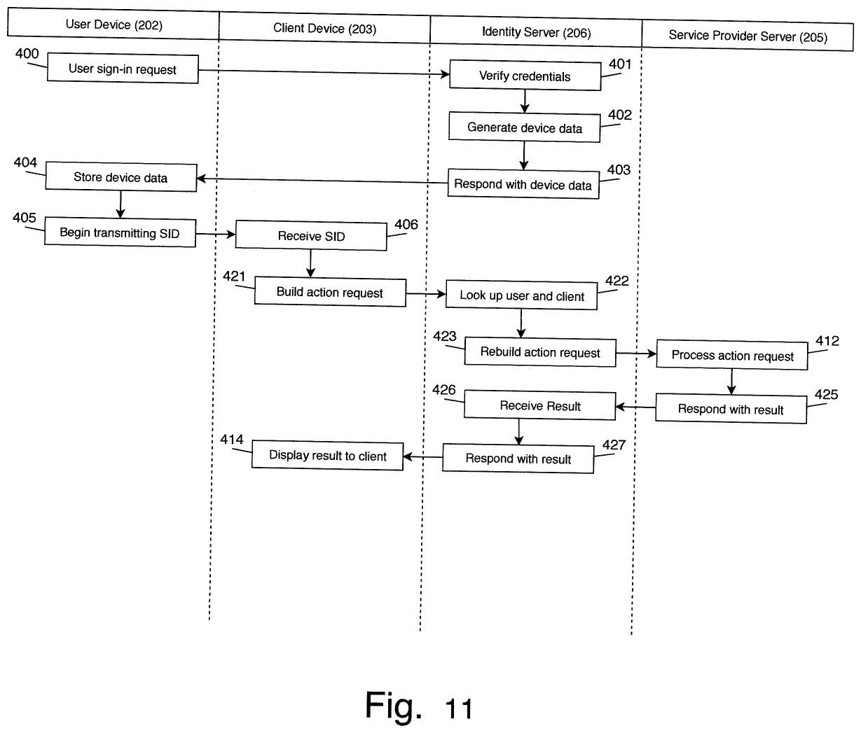

FIG. 11 illustrates the process of providing a service using the components of the identity network as defined in system 101.

Steps 400 through 406 in this system match those in system 100 as defined above in the description for FIG. 10.

In step 421, the software application on device 203 packages the SID with its service provider UID, and the category of service the software application on device 203 is configured to provide. The packaged data is then sent by device 203 to identity server 206.

In step 422, if the SID is not valid for any reason, or the user 201 does not have an account in the identity server 206 associated with the registered service provider whose UID was just passed, the identity server 206 responds to device 203 with an error response. As with system 100 it's unlikely that user 201 does not have an account. It is again mentioned for completeness. If the user 201 does have an account in identity server 206 which is associated with the service provider of the service provider UID just passed, it is passed on to step 423.

In step 423, the identity server 206 replaces the SID in the packaged data with the UID of the user 201 which is associated with the service provider of the service provider UID just passed, and forwards the package to the API endpoint for the service category on server 205.

Step 412 is the same as in system 100, where server 205 processes the data for the service.

In step 425, server 205 sends the service result back to identity server 206.

In step 426, identity server 206 takes the service result from server 205.

In step 427, identity server 206 forwards the result from the previous step to device 203 as a response to the original packaged data from device 203 to identity server 206.

Step 414 is the same as in system 100, where device 203 can now inform client 204 of the result. If client 204 is providing additional service(s) to user 201 based on the recent service result, they are now informed on the parameters for doing so.

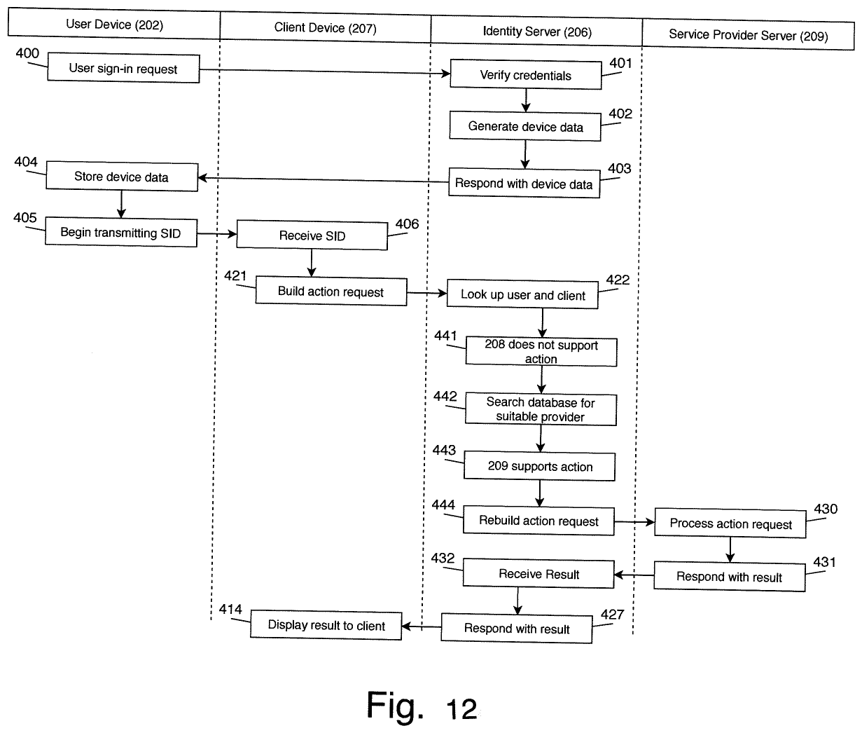

FIG. 12 illustrates the process of providing a service using the components of the identity network as defined in system 102.

Steps 400 through 406 in this system match those in system 100 as defined above in the description for FIG. 10 and FIG. 11.

Step 421 is the same as in system 101 where the software application on device 203 packages the SID with its service provider UID, and the category of service the software application on device 203 is configured to provide. The packaged data is then sent by device 203 to identity server 206.

In step 440, the identity server 206 receives the packaged data from device 207 as it did in system 101 from device 203, and server 206 validates the SID. If the SID is not valid for any reason, identity server 206 responds to device 207 with an error response.

In step 441, the identity server 206 searches for an account for user 201, for the service category requested in the packaged data from device 207, and with the service provider in control of server 208. If an account is found, processing continues as it did in system 101. In this system illustration however, an account is not found.

In step 442, the identity server 206 searches its records for a service provider that offers the requested service category, and also has an account for user 201. If no account is found, identity server 206 responds to device 207 with an error response.

In step 443, for this example, we assume that user 201 has an account with the service provider in control of server 209, and this service provider offers/supports the requested service category.

In step 444, the identity server 206 replaces the SID in the packaged data with the UID of the user 201, which is associated with the service provider in control of server 209. The identity server 206 then forwards the adjusted packaged data to the API endpoint for the service category on server 209.

In step 430, server 209 processes the data for the service.

In step 431, server 209 sends the service result back to identity server 206.

In step 432, identity server 206 takes the service result from server 209.

Step 427 is the same as in system 101 where identity server 206 forwards the result from the previous step (this time 432) to device 207 as a response to the original packaged data from device 207 to identity server 206.

Step 414 is the same as in systems 101 and 102 where device 207 can now inform client 204 of the result. If client 204 is providing additional service(s) to user 201 based on the recent service result, they are now informed on the parameters for doing so.

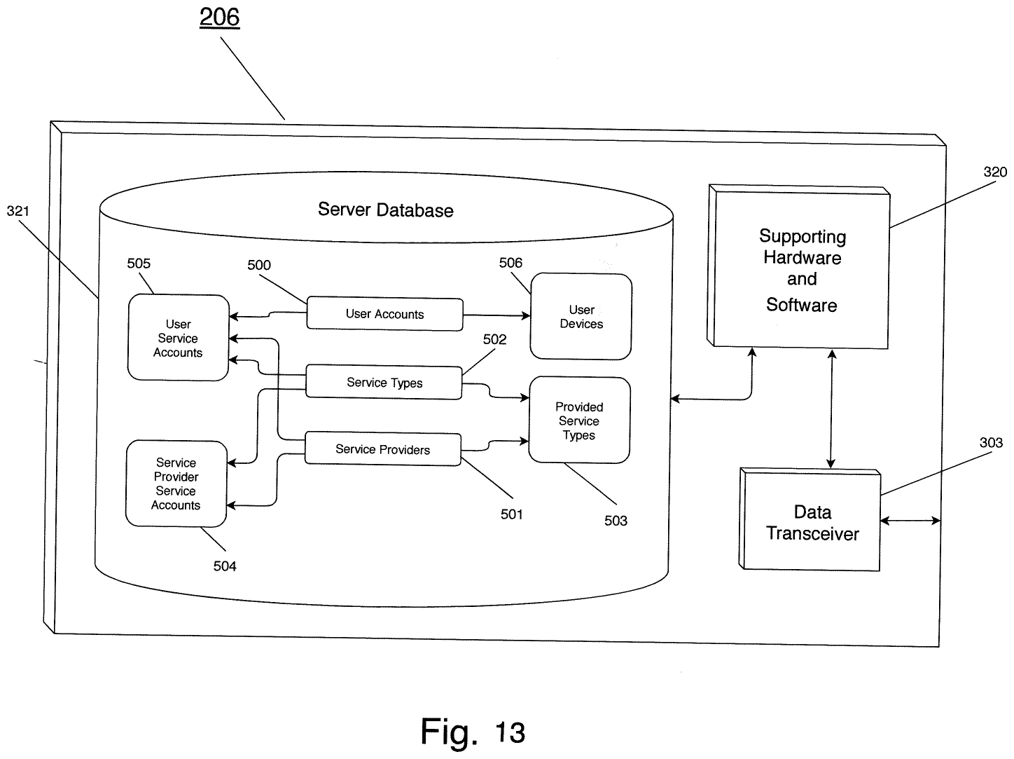

FIG. 13 illustrates in a high-level manner the architecture of the identity server 206, as it appears throughout. FIG. 13 is an illustration of one possible architecture only, and is not meant to exhaust all possible configuration options.

Identity server 206 may contain a data transceiver 303 capable of communication using any suitable communication network, method, and/or combination, such as but not limited to: wired local area network, cellular data, WiFi, and the Internet.

Identity server 206 may contain supporting hardware and software 320 capable of controlling and performing all operations required of identity server 206, in coordination with data transceiver 303, and server database 321.

Identity server 206 may contain a server database 321 which it structured in such a way to organize the relationships between user accounts 500, service types 502, and service providers 501. User accounts 500, service types 502, and service providers 501 all link together to user service accounts 505, which are used to identify service accounts for users when a service type is requested by a service provider. User accounts 500 link directly into the list of user devices 506, which is used to link authorized user devices 506 with user accounts 500. Service types 502 and Service Providers 501 link together in provided services types 503, which are used to look up potential service providers 501 which are capable of processing incoming service requests. Service types 502 and Service Providers 501 link together in service provider service accounts 504, which are used for when something needs to be transferred to a service provider, from another. For example if a payment needs to be made, an email needs to be sent, a file needs to be transferred, etc. FIG. 14 illustrates several possible SID configurations which could be used for some or all of the purposes defined herein. FIG. 14 is an illustration of three possible architecture only, and is not meant to exhaust all possible configuration options. The encoding method of the SID is not relevant either. Any data encoding scheme can be used, or used in combination. Some encoding examples include but are not limited to: JSON, CSV, and XML.

Configuration 601 of FIG. 14 illustrates a SID that could be used universally for all applications. This configuration contains a plain-text device UID 650, and employs a section of encrypted content 651. The device UID 650 was generated and supplied by the identity server 206 upon user and device authentication detailed above. The encrypted content 651 is encrypted using a public-private key pair generated and supplied by identity server 206, which is specific to the device on which the SID is created (such as user device 202). The encrypted content 651 may contain a device timestamp or generated UID 652, which are both detailed above. The encrypted content 651 may also contain additional request data 653, which is an optional component. The additional request data 653 can be completely custom in nature, and be defined by the software on the device creating the SID. It can be defined by the service provider, or be additional data required by the identity server for the requested service, for example.

Configuration 602 of FIG. 14 illustrates a SID that could be used universally for all applications. This configuration contains a plain-text device UID 650, which is the same in nature to that of configuration 601. This configuration uses a generated UID 654 (detailed above), instead of the optional device timestamp or generated UID. The timestamp cannot be used as it would be presented unprotected by encryption, and thus be at risk of stealing, and other malicious attacks. The reason the generated UID 654 may be used safely, is that each subsequent value cannot be predicted even from a small sample set. The device generating the SID, and identity server 206 both share the unique algorithm used to generate the generated UID 654, so only they can verify the generated UID 654. This configuration may also contain additional request data 653, which is the same in nature as with configuration 601. The only difference with additional request data 653 between this configuration and configuration 601, is that the contents of the additional request data 653 are not protected by encryption. In this configuration, care would need to be taken to ensure that the additional request data 653 does not contain any sensitive data, or UIDs.

Configuration 603 of FIG. 14 illustrates a SID that can only be used for specific events or locations. In this configuration, the whole content of the SID itself is encrypted with a public-private key pair generated and supplied by identity server 206. The key pair in this case is unique to each location or event that requests it. User devices such as user device 202, would have to be configured to download the appropriate public key for each event or location they were visiting. The device receiving the SID, such as client device 203, would need to be configured to identify to identity server 206 which event or location they, and the corresponding SID, belong to. This configuration may contain a ticket UID 655, which is unique to the user attending the event. Ticket UID 655 may also be a shared credential, or any other kind of credential; ticket UID 655 can be any kind of identifier appropriately identifiable by the service provider of the SID receiving device. This configuration may also contain a device timestamp or generated UID 652, and optionally some additional request data 653, both of which match the same of which are detailed in configuration 601.

As described above and shown in FIG. 14, the data set framework established in the preliminary information exchange between the PCD 202 and the remote identity server 206 contains data relating to a timestamp of the information sent to the remote identity server by the PCD.

As described above and shown in FIG. 14, the data set contains a unique identifier generated by combining said data relating to the timestamp with a unique mathematical algorithm provided to the PCD by the remote identity server, at the time the device sent its then-current timestamp and received its credentials.

As described above and shown in FIG. 14, the data relating to the timestamp and/or the unique mathematical algorithm within the data set is encrypted such that it can only be decrypted by the remote identity server.

As described above and shown in FIG. 14 at 601, the whole dataset is encrypted such that it can only be decrypted by the remote identity server.

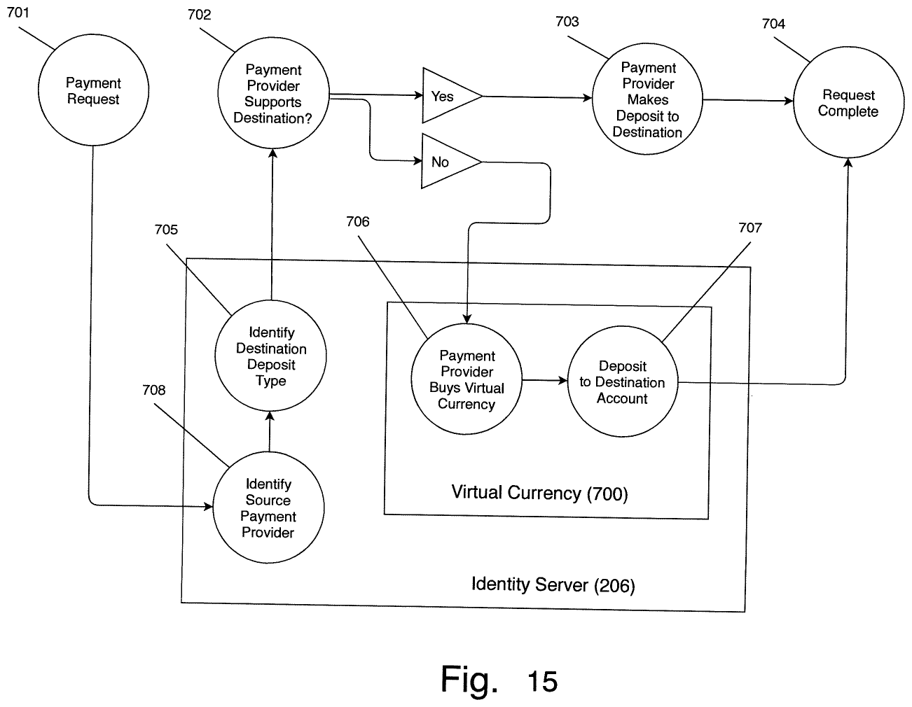

FIG. 15 illustrates how a virtual currency can be incorporated into the identity server 206, in order to facilitate payments between service providers who are not otherwise equipped to do so.

A payment request 701 is initiated by a client device such as 203, and sent to the identity server 206. In 708 the identity server 206 identifies the user which is making the payment, and their payment provider and account of choice. From the payment request 701 is included the payment recipient; the identity server 206 in 705 identifies the type of payment deposits the recipient can accept.

To finish 705, the identity server sends the identification of the user making payment, and the type of deposit to the user's payment provider. In 702 the payment provider checks whether it supports the deposit type required of the payment recipient. If in 702 the payment provider finds it is capable of making the payment correctly to the deposit, it makes the deposit in 703, and the payment is complete in 704.

If in 702, the payment provider finds it does not support the deposit type required of the payment recipient, in 706 it makes a purchase of the virtual currency 700. The amount of the purchase matches that of the amount of the payment request 701, adjusted for the exchange rate defined by identity server 206 between the payment currency, and the virtual currency 700. Virtual currency 700 can be of any type, such as but not limited to: Bitcoin, Ethereum, or a new form of virtual currency. In 706, the payment provider makes the purchase with the funds from its account for the user making the payment in 701. In 706, the payment provider need not make a purchase of virtual currency 700 if it already holds a balance of the currency.

In 707 the appropriate amount of virtual currency 700 for the payment request 701 is deposited in the payment recipient's virtual currency 700 account; the payment in then complete in 704.

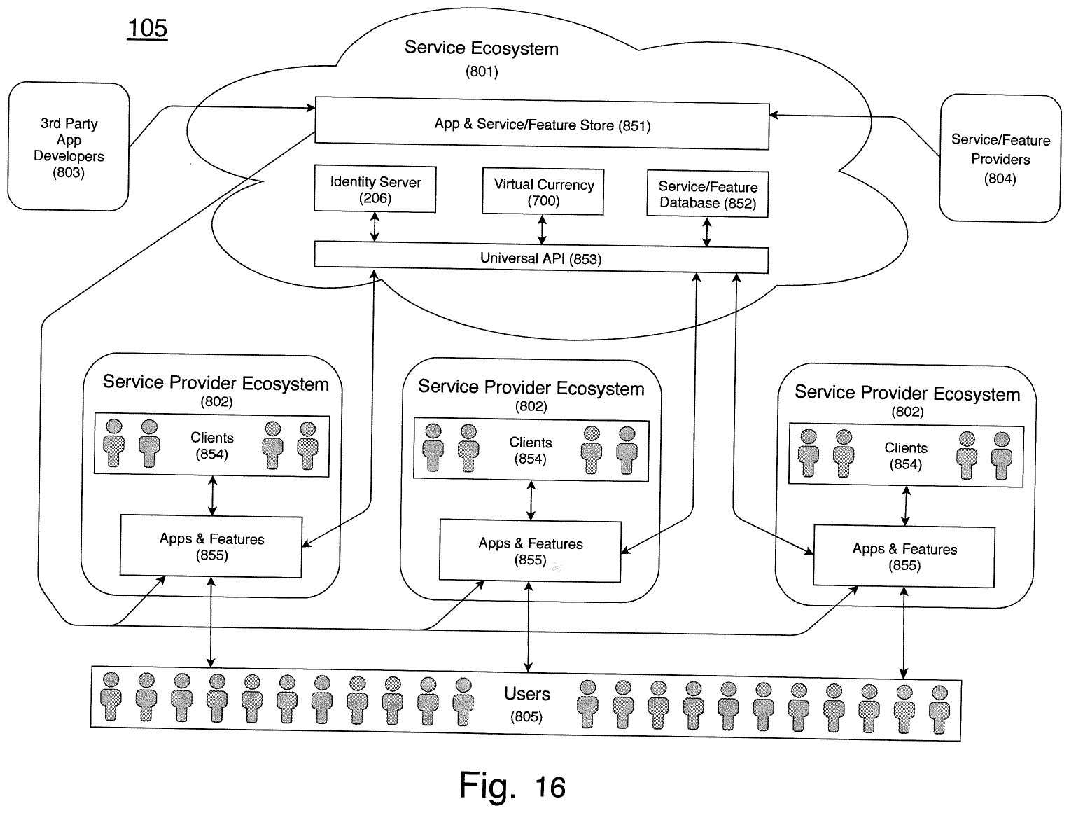

FIG. 16 illustrates a system or network 105 where the identity server 206 and virtual currency 700, are part of a larger scalable service ecosystem 801. In this system or network, software, services, and features can be chosen ‘a-la-cart’ from the app & service/feature store 851 by service providers for their own ecosystems (802), to assist them with providing their own services. Since all software and features are designed around a common universal API 853, and service/feature database 852, all software and features can be used interchangeably depending on the needs of the provider. For example, if a grocery store needed a point of sale system, any point of sale software in the app & service/feature store 851 could be used. If a new and improved point of sale application became available, the grocery store could switch over to it with zero impact, or run both concurrently; the grocery store could according to system 105, run every point of sale application simultaneously without any issue. Now that same grocery store could choose an inventory or purchasing application as well, which would use the same data as the point of sale. On the service/feature side, the grocery store could order an accounting service, where a 3rd party accounting firm uses the recorded data for the store, and does the books. The grocery store could sign up for an automated re-order and delivery service, where a third party monitors the stores data, and automatically ships new inventory to the store. To keep goods and services flowing quickly and smoothly, virtual currency 700 can be used in the service provider ecosystems 802 (ie. grocery store, event centre, service franchise), by the app developers 803, and by the service/feature providers 804.

In system 105, service provider ecosystems 802 can be any type of organized structure; anything from a single contractor, to a chain stores, or even a category of stores. Whomever, or whatever entity that sets up a service provider ecosystem 105, will have their choice of any 3rd party apps and features that are available in the app & service/feature store 851, and/or any apps and features developed by and for the service provider, and/or another entity. These apps and features 855 may be free or paid, and can be used by the service provider within their ecosystem 105 by clients 854, which are similar to 204, on devices like 203, and by users 805, which are similar to the user 201, on devices like 202. The apps offered within the app & service/feature store 851 may also offer the ability to be adjusted to match the purchasing service providers branding style; thus, making the app appear as a product of the purchasing service provider, instead of the app developer.

Apps and features 855 may also be configured to be hierarchal in nature, such that higher level apps and features 855 may control the function of lower level/submissive apps and features 855. This permits tighter, more convenient control over apps and features 855 in service provider ecosystems 802, by centralizing that control to one or more specially designed apps and features 855.

In system 105, the specification of the universal API 853, and the structure of the service/feature database 852, would be published information available to all 3rd party app developers 803, and service/feature providers 804. Potentially the API and 853 and structure of database 852 could also be made open-source to encourage more wide-spread adoption, and speed corrections and enhancements.

In system 105, 3rd party app developers 803, and service/feature providers 804 could use virtual currency 700 as a foundation for their own virtual currency, or for that of a service provider ecosystem 802. This would enable service provider ecosystems to create a more branded and complete experience for their users 805, while maintaining the technical strength and security of the central universal virtual currency 700.

There is no limited to the number of devices that could be in use by users 805 and clients 854 alike, in any one service provider ecosystem 802, at any time. These devices may or may not have a data connection with service ecosystem 801, depending on a variety of planned and unplanned circumstance. In those cases, the devices, and their installed apps and features 855, may in some cases make decisions on their own, as a collective using a blockchain or other group method, in a hierarchal structure with some devices making decisions for others, or in a combination of some or all; data created in this way could be uploaded to the service ecosystem 801 when a connection becomes available. These individual and/or group decision systems could also be used in cases were a reliable connection to the service ecosystem 801 does exist, in order to reduce communications traffic with the service ecosystem 801, and improve performance and reliability.

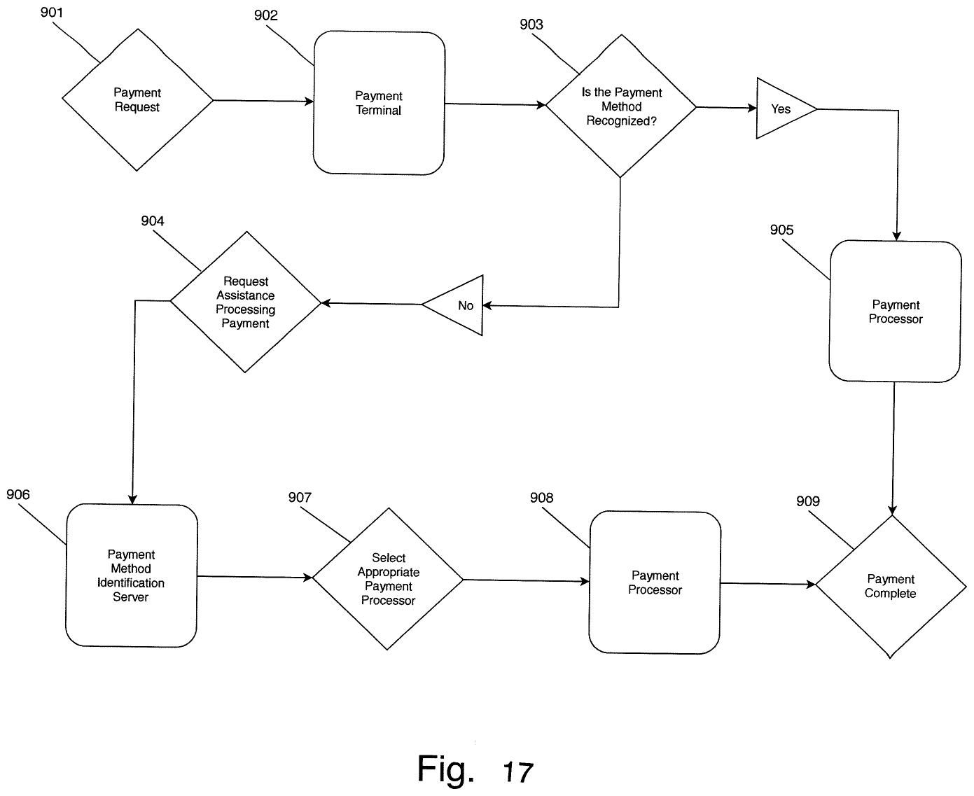

FIG. 17 illustrates a process by which a payment terminal can be made to handle all forms of payment, including those it is not familiar with, and/or designed to handle. A payment request 901 is made to payment terminal 902. The payment request can be of any method but must use a communications protocol that payment terminal 902 is equipped for. Some examples include but are not limited to: magnetic swipe, NFC, chip card, and barcode.

Payment terminal 902 receives the payment request and attempts to identify the payment method in 903. In 903 if the payment method is recognized, the terminal may take whatever action is appropriate and that it was configured to do, but in this example it forwards the payment request to the payment processor 905. The payment processor 905 makes what credits and debits are required of it, and the payment is complete in 909.

If the payment terminal 902 does not recognize the payment method in 903, it requests assistance in identifying and processing the payment in 904. The assistance request 904 is made to a payment method identification server 906, which can be any suitable computing device, with the appropriate communications systems for communicating with the payment terminal 902. The identification server 906 identifies the method of payment based on its data and software, and selects an appropriate payment processor 908. To finish 907, the identification server 906 sends the appropriate payment request data to payment processor 908. Payment processor 908 makes what credits and debits are required of it, and the payment is complete in 909.

As described above and shown in FIG. 17, a payment terminal forwards an input it cannot process along with details of the amount to charge, and merchant to credit, to a server which identifies the input format and content and processes the payment accordingly.

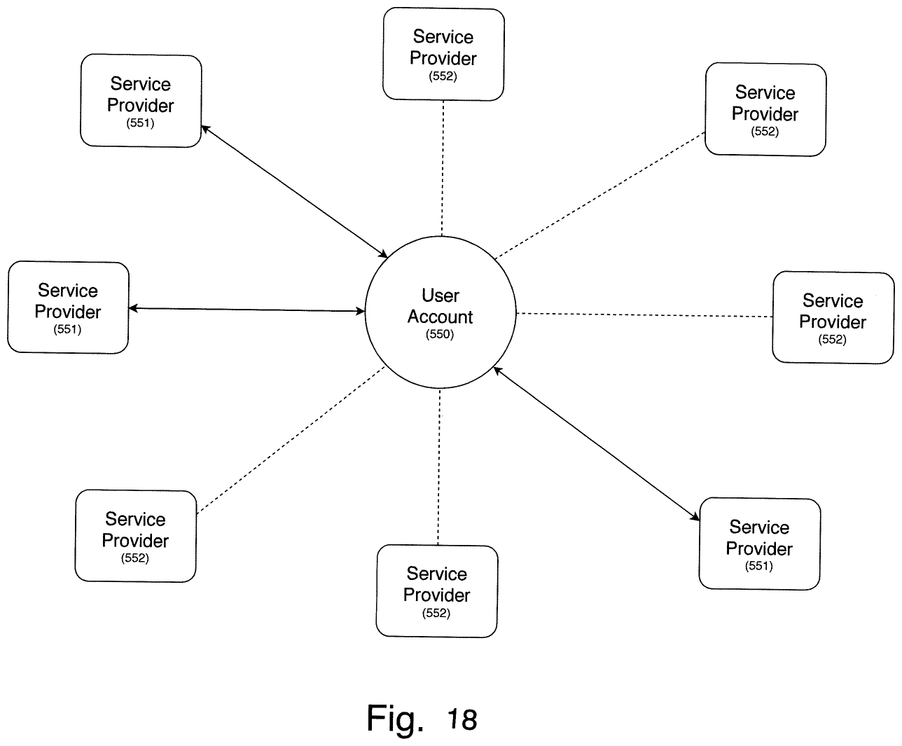

FIG. 18 is an extension of FIG. 13, which illustrates the relationship between a user 201, and a service provider 551, which is recorded in 501, and which may have, and control a service provider ecosystem 802, via their user service accounts 505. A user account 550, which is one of the user accounts 505, is always in a position to immediately connect to a service provider 552, stored in service providers 501, via a user service account 505. When the user 201 wishes to have an account with a service provider 552, using an interface with access to identity server 206, simply selects the desired service provider 552, and agrees to some corresponding terms of service, should the selected service provider 552 require it. A new record is then created in user service accounts 505, and process is completed with the service provider now becoming a service provider 551, with respect to the user 201. The selected service provider 551 will now have appropriate access to the user 201's user service account 550 as required and authorized by their service type stored in service types 502, and the user 201 will now have appropriate access to the service offered by the selected service provider 551.

If a user 201 no longer wishes to have a user service account 505 with a service provider 551, they may use the same, or similar, interface to identity server 206 to disable or delete their user service account 505 with the selected service provider 551. The service provider 551 reverts to being a service provider 552, with respect to the user 201. The service provider 552 will no longer have access to the user 201's user service account 550, and the user 201 will no longer have access to the service provider 552's services offered.

As described above, the network 105 is connected to the remote identity server 206 for centralizing and standardizing software application or service data such that it can be shared, viewed, and utilized universally by any number of software applications and services indicated at clients 852. The software applications or service data 855 are compatible with the network, and the specifications for the format and structure of the transactions are documented and at least partly shared. There is provided a universal interface 853 for communications between said remote identity server 206 and said software application or service data 852.

As shown in FIG. 16 at item 700 a virtual currency is available in the network as a universal payment means between any group or user associated with the network.

As shown in FIG. 16 the software applications and/or services communicate 855 together and use their combined data to more accurately make group and user decisions. A connection to the network is fully active but the software applications and/or services 855 continue to work mostly together to reduce load on the connection to the universal interface 853.

An intermediary lesser control server within the service provider ecosystem 802 is implemented in closer proximity to the software application and/or services to further reduce load on the connection to the universal interface. The lesser control server also behaves as a peer in some cases, to assist with the application and/or service decision making.

Data pertaining to usage of the network by the PCD is tracked by service/feature database 852, or other capable and suitable system, for statistical, analytical, and reporting purposes wherein data is provided to and/or accessed by service providers. The network is programmed at the API 853 in such a way that personal/private and/or identity information is hidden.

Within the service ecosystem 801 and/or service provider ecosystem 802, advertising and/or marketing is developed and/or delivered to users and/or groups of users or accounts based on specific activities of each within the network.

The universal interface 853 forwards some of all of the input to another service provider 804 of its choosing based on the input to assist with or perform a service.

The applications 855 are built and configured in a hierarchal way, such that some software applications control the permissions, and features of other submissive software applications; thus, permitting control over how some software applications function, via one or more higher level software applications.

In operation the user creates new accounts with service providers 802 simply by selecting them via the interface 853 of the network.

In operation the user acquires new accounts with service providers 802 automatically when the user or account interacts with that service provider using the network.

In operation two or more users may transfer digital assets between one another, record the transfer of physical or monetary assets, and/or a combination of each.

Where there is no immediate communication connection between devices of users of all parties involved in the transfer, and the universal interface, the transfer may be recorded by one or more devices, of which may or may not be one of the devices of an involved party, but which could also or instead be that of a trusted third party.

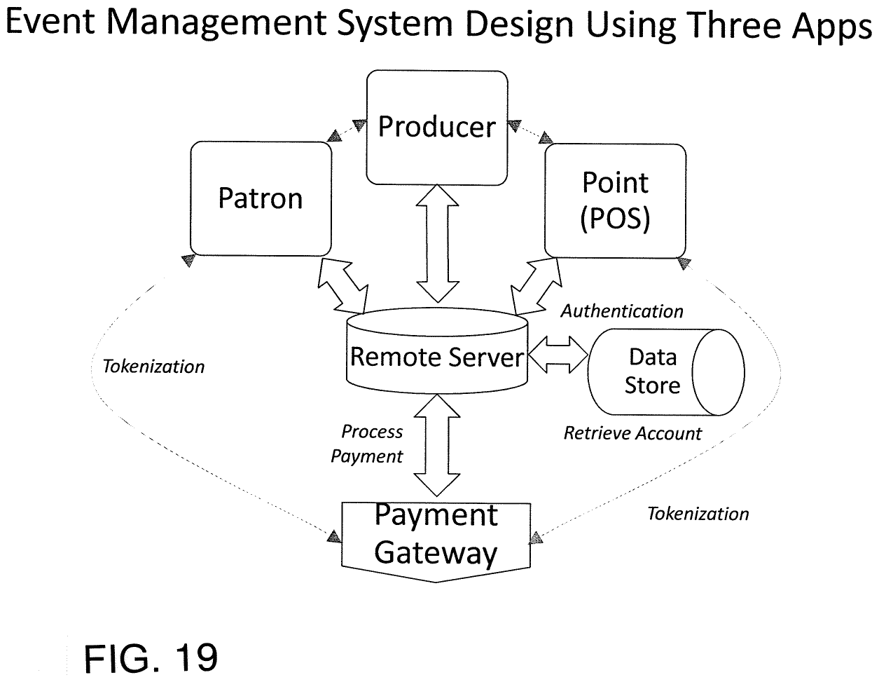

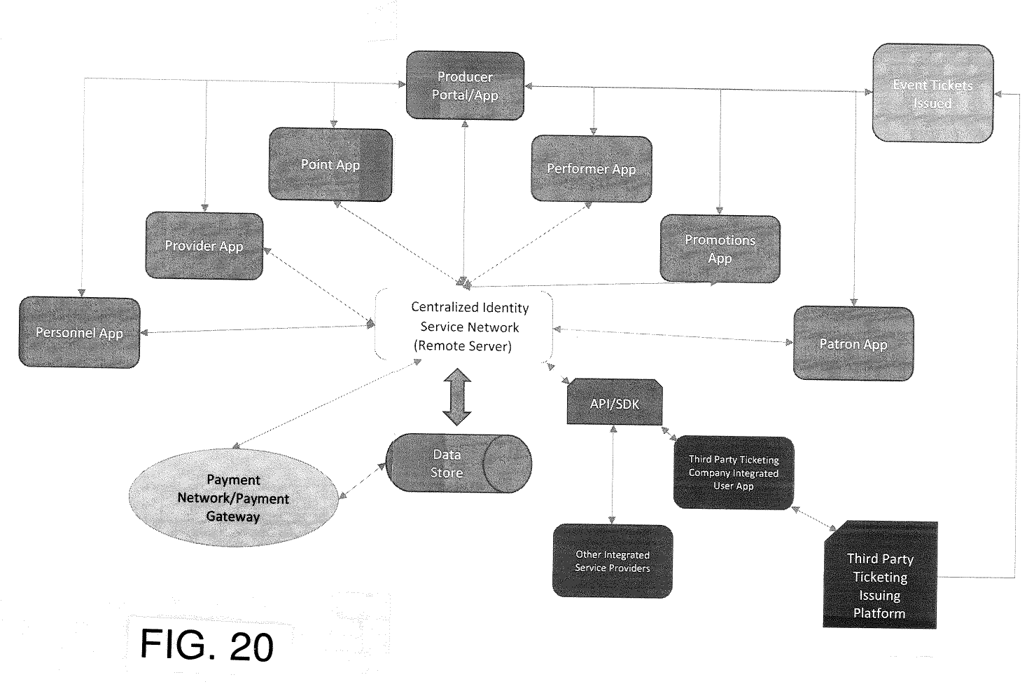

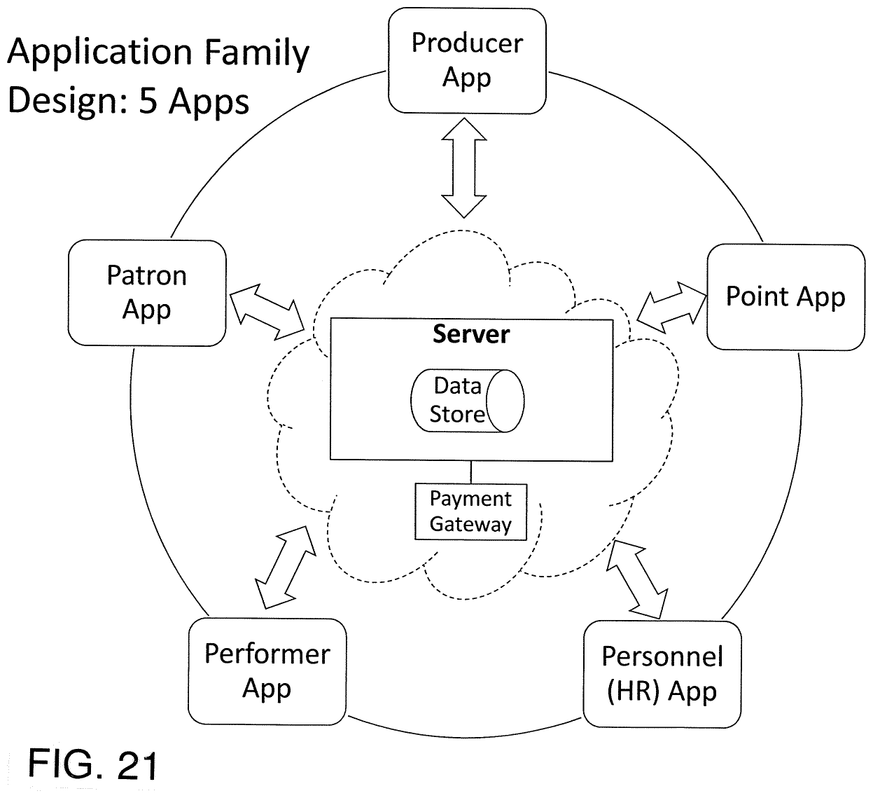

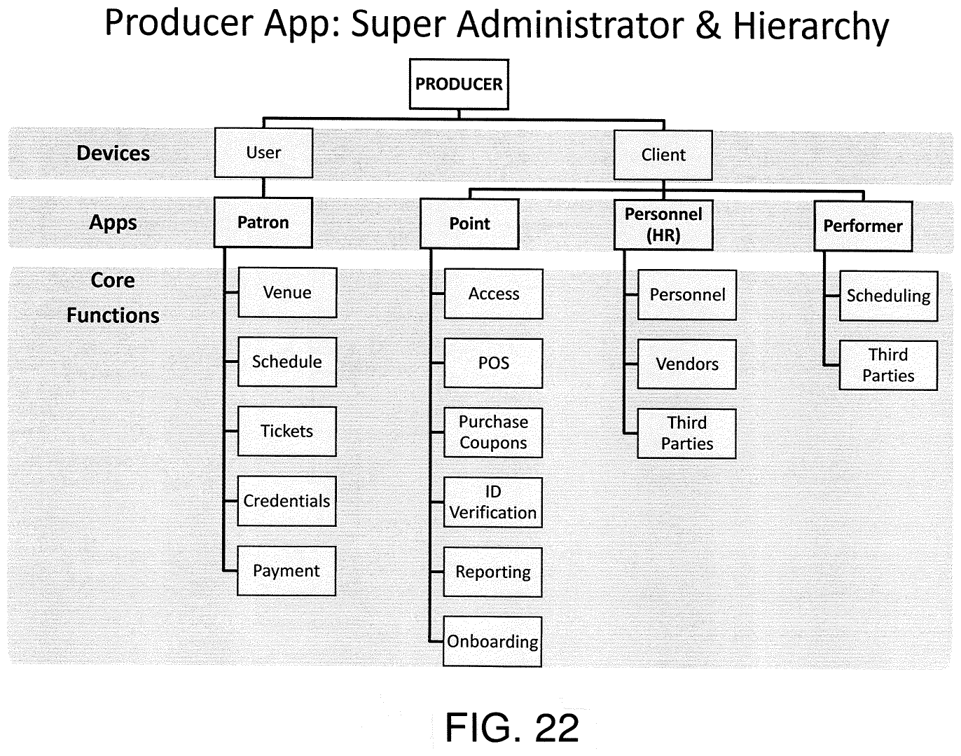

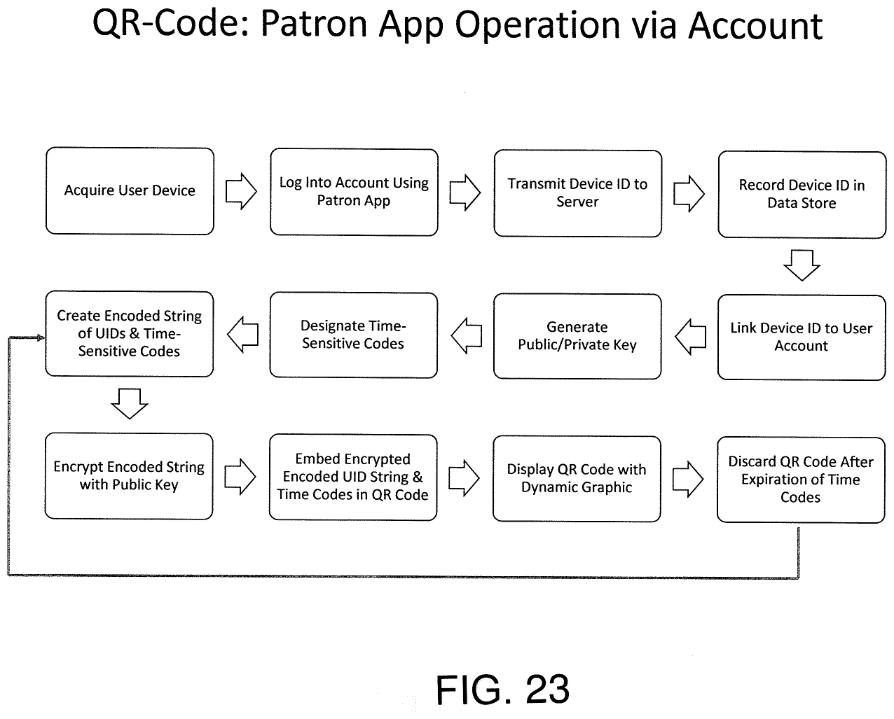

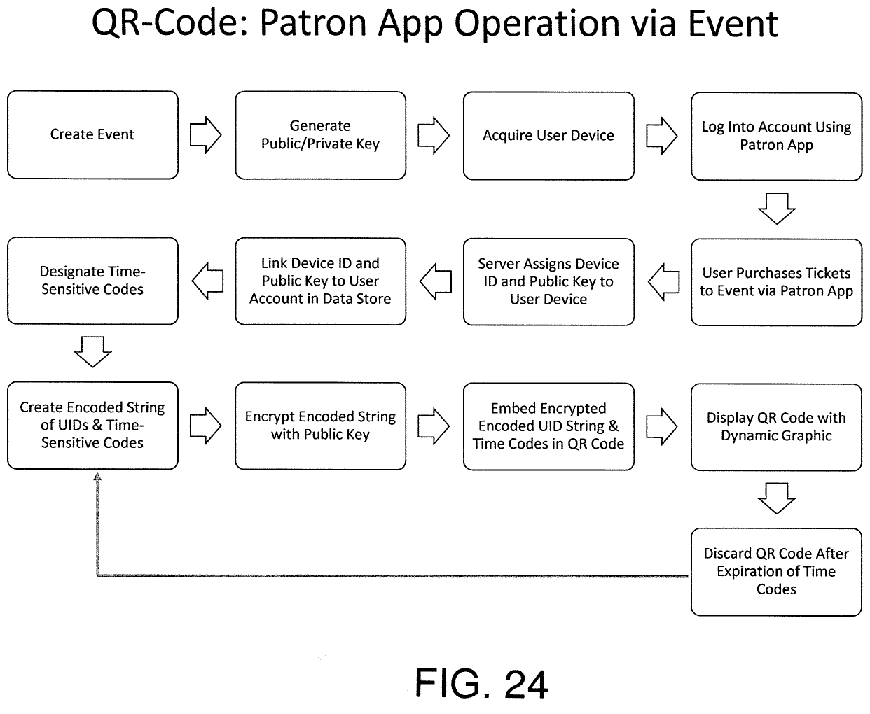

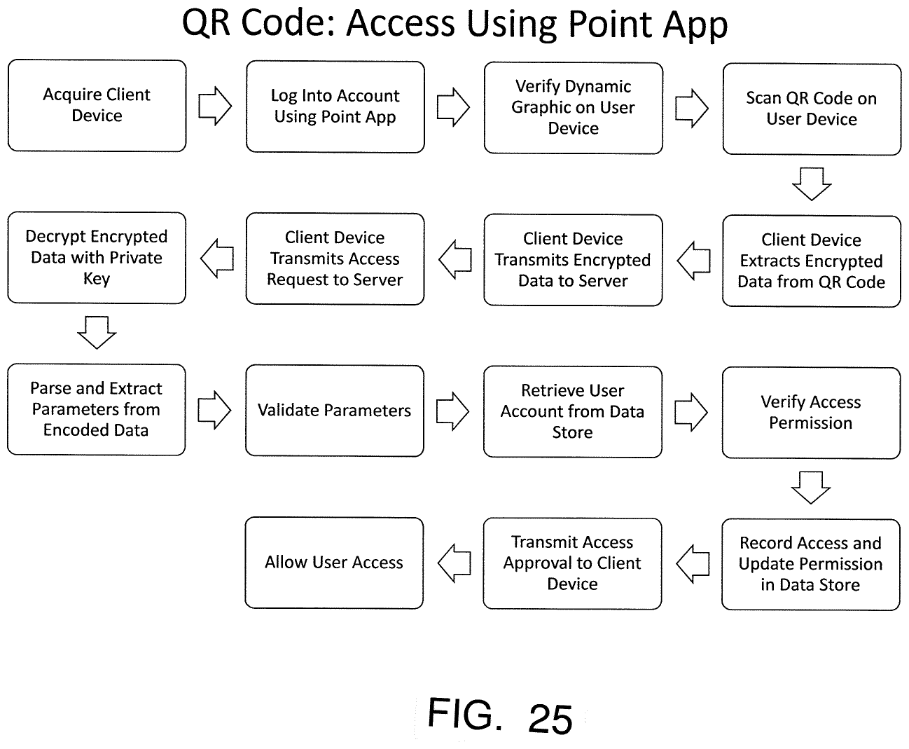

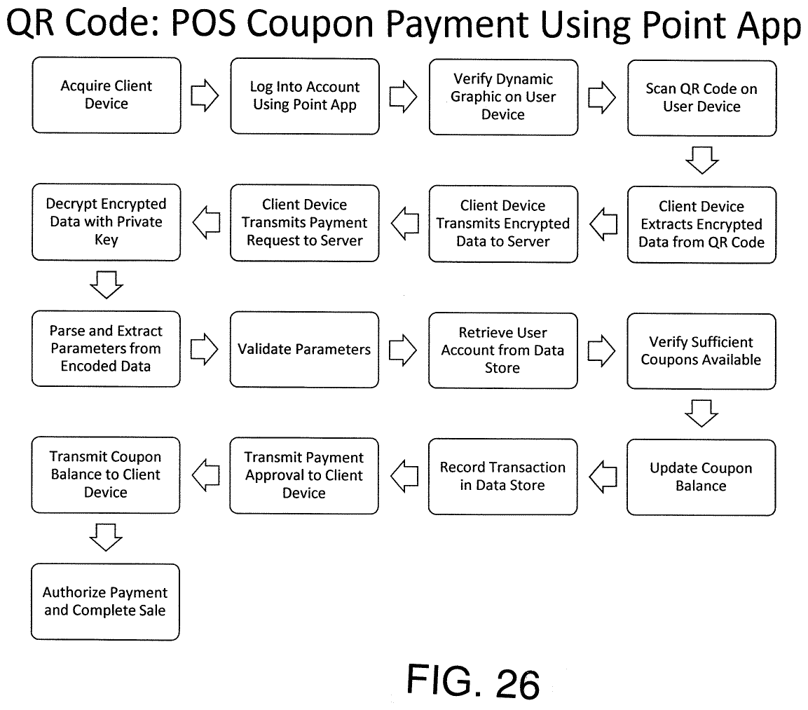

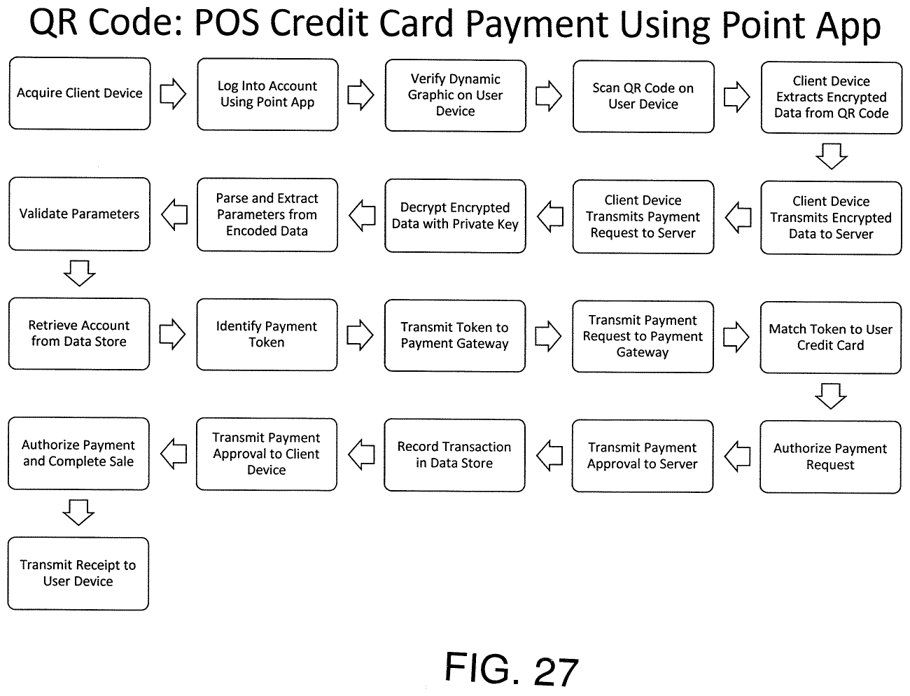

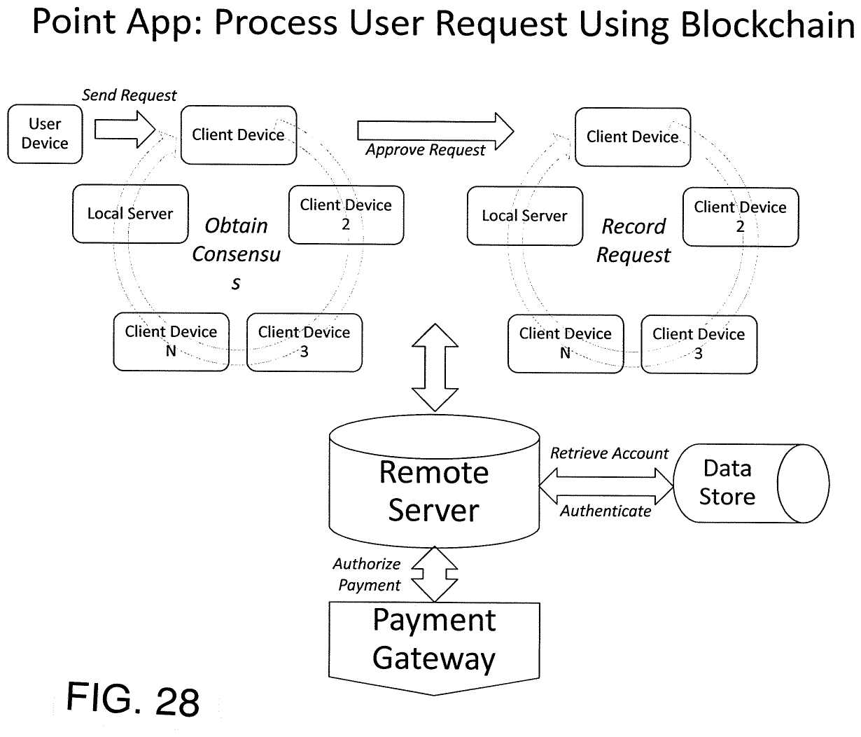

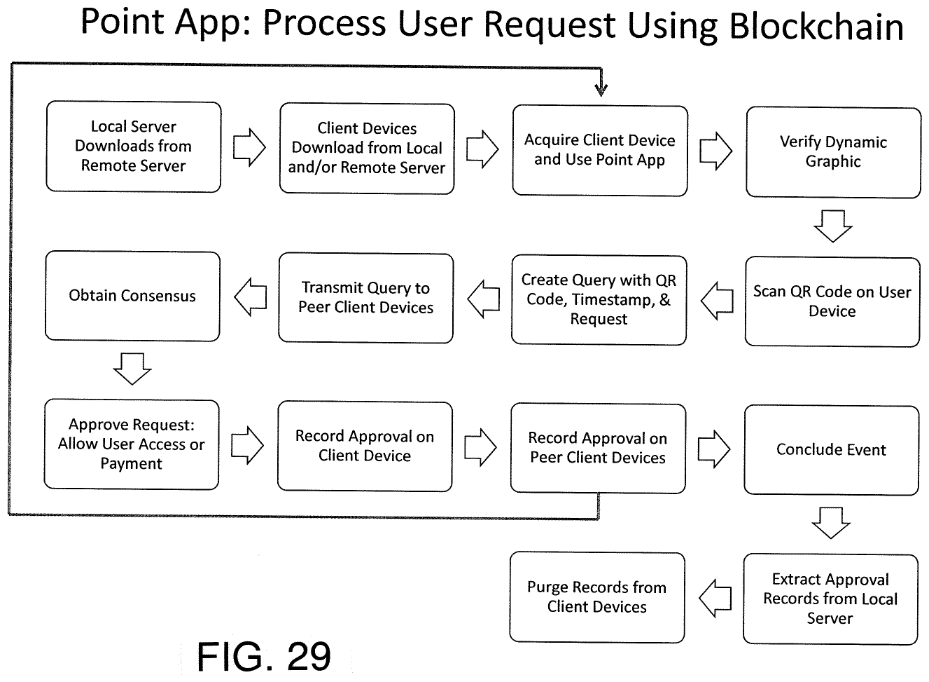

FIGS. 19 to 29 show a specific example of an arrangement as described above. FIG. 20 illustrates the event management system having an application ecosystem made up of multiple applications, including 3rd party applications, using the Secure Identity Network to communicate and execute smart contracts. The drawing also provides the hierarchy of the applications and identifies the event administrator (Producer) application as the highest role which can administer and instruct the other applications to perform tasks.

1. A method for completing transactions for physical products and services between a plurality of users and a plurality of suppliers of the products and services; who is a supplier of goods and/or services;
where at least one of the plurality of suppliers is a supplier of live events and provides to at least some of the plurality of users an electronic ticket for entry into the live event;
where at least one of the suppliers is a supplier of the physical products to be obtained by at least some of the plurality of users;
each of the plurality of users having a personal communication device (PCD);
the method comprising:
providing to each of the suppliers a respective one of a plurality of a receiving communication device;
on a remote identity server, for each of the plurality of users, in preliminary information exchange between the PCD and the remote identity server, establishing a data set structure sharing a relationship between the remote identity server and the PCD;
in the event that one of the plurality of users wishes to obtain goods and/or services from at least one of the plurality of suppliers, causing the PCD to generate and transmit to the receiving device a data set;
causing the receiving device to forward the received data set to the remote identity server for validation, processing, and identification of the user, the remote identity server acting to provide data to the receiving device identifying the user;
the data set being established such as to only be recognizable as valid by said remote identity server, and to not be easily reproduced by an unauthorized third party;
wherein the method combines e-ticketing and purchasing under one digital platform;
wherein the method acts to align a mobile/cashless payment option information on the remoted identity server with the user, providing the receiving communication devices with a single method to transmit any information associated with the user that is requested by one of said receiving communication devices.

2. The method according to claim 1 wherein the data set, whose structure was established in the preliminary information exchange between the PCD and the remote identity server, contains a data relating to a timestamp of the information sent to the remote identity server, via the receiving device, by the PCD.

3. The method according to claim 2 wherein the data set structure established in the preliminary information exchange between the PCD and the remote identity server contains a data relating to a difference between a timestamp of the information sent from the PCD and a timestamp of the remote identity server.

4. The method according to claim 2 wherein the data set contains a unique identifier generated by combining said data relating to the timestamp with a unique mathematical algorithm provided to the PCD by the remote identity server, at the time the device sent its then-current timestamp and received its credentials.

5. The method according to claim 2 wherein the data relating to the timestamp and/or the unique mathematical algorithm within the data set is encrypted such that it can only be decrypted by the remote identity server.

6. (canceled)

7. (canceled)

8. The header according to claim 1 wherein the PCD does not have a data connection to remote identity server, and instead relies upon a local server, or local data on the device in order to complete the identification, where the local server or data contains the required special relationship data that would otherwise be stored on and decrypted by the remote identity server.

9. The header according to claim 1 wherein the PCD is required only to transmit the data set to the receiving device so that no two-way communication is required of the PCD after the data set was initially granted and provided by the remote identity server.

10. The header according to claim 1 wherein when the receiving device receives back from the remote identity server a unique identification of the user and the remote device uses that identification to provide said goods and/or service.

11. The method according to claim 10 wherein the unique identification received is unique to the PCD.

12. (canceled)

13. The header according to claim 1 wherein the receiving device also sends service data/parameters along with the data set to the remote identity server which then performs a service.

14. The header according to claim 1 wherein the remote identity server forwards a service request to one or more service providers, as defined by the service data or parameters to perform or assist to provide said goods and/or service.

15. (canceled)

16. The header according to claim 1 wherein the user is authenticated by the remote identity server on a plurality of different devices and/or software applications simultaneously.

17. (canceled)

18. The header according to claim 1 wherein the PCD and receiving device switch roles relating to the user authenticated and software configured on the device.

19. The header according to claim 1 further comprising providing a network connected to said remote identity server for centralizing and standardizing software application or service data such that it can be shared, viewed, and utilized universally by any number of software applications and services where the software application or service data are compatible with the network and where specifications are documented and at least partly shared, and there is provided a universal interface for communications between said remote identity server and said software application or service data.

20. The method according to claim 19 wherein a virtual currency is available in the network as a universal payment means between any group or user associated with the network.

21. The method according to claim 19 wherein the software application and service data communicate together and use their combined data to more accurately make group and user decisions.

22. The method according to claim 19 wherein a connection to the network is fully active but the software application and service data continue to work mostly together to reduce load on the connection to the universal interface.

23. The method according to claim 14 wherein an intermediary lesser control server is implemented in closer proximity to the software application and/or services to further reduce load on the connection to the universal interface.

24. The method according to claim 23 wherein the lesser control server also behaves as a peer in some cases, to assist with the application and/or service decision making.

25. The method according to claim 19 wherein data is provided to and/or accessed by service providers in such a way that personal/private and/or identity information is hidden.

26-32. (canceled)
